(19) United States
(12) Patent Application Publication
(10) Pub. No.: US 2022/0324132 A1
(43) Pub. Date: Oct. 13, 2022

(54) CUTTING DEVICE FOR CUTTING NARROW STRIPS FROM A STRIP OF MATERIAL, IN PARTICULAR A RUBBERIZED STRIP OF MATERIAL

(71) Applicant: Karl Eugen Fischer Gesellschaft mit beschrankter Haftung, Burgkunstadt (DE)

(72) Inventors: Stefan LINDNER, Kulmbach (DE); Michael SCHMIDT, Heinersreuth (DE); Manuel SCHMITT, Ebensfeld - Kleukheim (DE)

(21) Appl. No.: 17/707,111

(22) Filed: Mar. 29, 2022

(30) Foreign Application Priority Data
Apr. 8, 2021 (DE) 10 2021 108 795.3
Apr. 8, 2021 (DE) 20 2021 101 889.5

(51) Int. Cl. B26D 7/02; B26D 3/00; B26D 1/04; B26D 7/32

(52) U.S. Cl. CPC B26D 7/025; B26D 3/003; B26D 1/04; B26D 7/32; B26D 7/086

(57) ABSTRACT

A cutting device for cutting narrow strips from a material web in or on which magnetically couplable elements are embedded or arranged at defined spacings behind one another in the web longitudinal direction, including a blade table arranged on a device frame, and on which the material web to be cut can be positioned, a cutting apparatus including a cutting blade which can be moved out of a starting position into a cutting position relative to the blade table, and a gripping device which receives and transports a cut strip and can be moved relative to the blade table. Either the gripping device including a hold-down section placeable for cutting purposes onto the material web positioned on the blade table and fixes the material web during the cutting on the blade table, and a magnetic element which interacts magnetically with the magnetically couplable element of the cut strip for fixing the strip on the gripping device for transport into a dispensing position, and the hold-down section including a recess, through which the cutting blade can be moved to the blade table into the cutting position, or the gripping device including a hold-down section placeable for cutting purposes onto the material web which is positioned on the blade table and fixes the material web during the cutting on the blade table, and a magnetic element which interacts magnetically with the magnetically couplable element of the cut strip for fixing the strip on the gripping device for transport into a dispensing position, and at least one further hold-down element being provided which can be placed onto the material web for cutting purposes spaced apart from the hold-down section with the configuration of a clearance, it being possible for the cutting blade to be moved through the clearance to the blade table into the cutting position.

### CROSS-REFERENCE TO RELATED APPLICATIONS

The present application claims priority of DE 10 2021 108 795.3, filed Apr. 8, 2021 and DE 20 2021 101 889.5, filed Apr. 8, 2021, the priority of these applications are hereby claimed, and the application is incorporated herein by reference.

### BACKGROUND OF THE INVENTION

The invention relates to a cutting device for cutting narrow strips from a material web, in particular a rubberized material web.

For different applications, it is sometimes necessary for a narrow strip of a material web to be arranged on or integrated into an object, in which strip at least one magnetically couplable element is embedded or on which strip a magnetically couplable element of this type is arranged. Here, the material web serves as a carrier for the element. An element of this type serves, for example, for labeling purposes, with the result that the object, on which the element is arranged, can be labeled or identified on the basis of this element. The material web is a flexible web material made from plastic, preferably from a rubberized material, industrially manufactured elastomers being meant here. Depending on the material, it can also be adhesive. A magnetically couplable or magnetically interacting element can be, for example, a metal strip or a magnet or the like, the presence of which on the equipped object can be detected by means of a suitable detection or reading unit. In particular, the element can be an RFID chip, on which defined information can be stored which can then be read out on the respective object, equipped with the RFID chip, in order to identify it.

One exemplary application where strips of this type which are fitted with at least one element can be installed is the field of tire production. By way of the integration of a strip of this type, fitted with an element, into the tire during the building process of the tire, each single tire is provided individually with a labeling element of this type, that is to say, for example, an RFID chip, with the result that it can be identified. For example, corresponding information with regard to the manufacturing date, the manufacturing batch, the permissible filling pressure, etc. can be stored on the RFID chip and can be read out as required. This exemplary application is not restrictive, however, and applications in other fields are also conceivable.

Within the context of the production of strips of this type, the material web is first of all produced, in which material web the magnetically couplable elements, that is to say, for example, the RFID chips, are embedded or on which they are arranged. To this end, the separated elements or RFID chips are placed, for example, onto a first material web, that is to say, for example, a first rubber web, after which a second material web, that is to say a second rubber web, is placed onto this first material web and therefore onto the positioned elements, with the result that the elements or RFID chips are embedded in this case. This accordingly results in a sandwich web, that is to say a corresponding, dual-layer rubberized material web, the individual layers of which, however, can ultimately no longer be separated on account of their adhesiveness.

It is then necessary to cut off the individual strips from this material web, each strip comprising at least one element. However, the cutting of narrow strips is problematic, in particular, when very narrow strips are to be cut, for example when the strip width lies in the range of a few millimeters, for example from approximately 8 to 12 mm. On account of the flexibility of the material web and also on account of its sometimes present adhesiveness, problems arise with the use of a cutting blade resulting from any movement of the material web during cutting, with the result that inaccuracies can occur in the case of subsequent cuts, and consequently therefore exact cutting of the desired strip geometry and/or strip width is not ensured. This is required, however, since corresponding requirements are made of the permissible strip size in relation to further processing.

### SUMMARY OF THE INVENTION

The invention is therefore based on the problem of specifying a suitable cutting device for cutting narrow strips from a material web, in particular a rubberized material web.

In order to solve this problem, according to the invention, a cutting device is provided for cutting narrow strips from a material web, in particular a rubberized material web, in or on which magnetically couplable elements are embedded or arranged at defined spacings behind one another in the web longitudinal direction, comprising a blade table which is arranged on a device frame, and on which the material web to be cut can be positioned, a cutting apparatus comprising a cutting blade which can be moved out of a starting position into a cutting position relative to the blade table, and a gripping device which receives and transports a cut strip and can be moved relative to the blade table,
either the gripping device comprising a hold-down section which can be placed for cutting purposes onto the material web which is positioned on the blade table and fixes the material web during the cutting on the blade table, and a magnetic element which interacts magnetically with the magnetically couplable element of the cut strip for fixing the strip on the gripping device for transport into a dispensing position, and the hold-down section comprising a recess, through which the cutting blade can be moved to the blade table into the cutting position,
or the gripping device comprising a hold-down section which can be placed for cutting purposes onto the material web which is positioned on the blade table and fixes the material web during the cutting on the blade table, and a magnetic element which interacts magnetically with the magnetically couplable element of the cut strip for fixing the strip on the gripping device for transport into a dispensing position, and an at least further hold-down element being provided which can be placed onto the material web for cutting purposes spaced apart from the hold-down section with the configuration of a clearance, it being possible for the cutting blade to be moved through the clearance to the blade table into the cutting position.

The cutting device according to the invention makes exact cutting even of very narrow strips possible, for example with a section width between 8 mm and 12 mm, in the case of a preferred strip length of between 70 to 80 mm, even in the case of the use of a relatively adhesive, rubberized material web. At the same time, the cutting device makes it possible in a simple way for a cut strip of this type to be received by means of a gripping device, via which the strip can be transported away.

To this end, the cutting device has a cutting apparatus with a cutting blade which can be moved out of a starting position into a cutting position, in particular an ultrasonic cutting blade comprising a blade unit in the form of an ultrasonic booster with a corresponding blade (usually called a horn) or a heatable blade, with a correspondingly wide cutting edge. This cutting blade can expediently be moved in a linear manner from above onto the material web, which material web lies on a corresponding blade table. The blade is moved into a corresponding cutting position, this blade, after being placed on the material web and until the cutting position is reached, severing the material web.

In accordance with a first alternative, the material web is fixed on the blade table by means of a gripping device during the entire cutting operation. This gripping device serves firstly to fix the material web and subsequently the cut strip during the entire duration of the blade movement, and secondly at the same time also serves to receive and fix the strip for the subsequent removal. In order to fix the material web, the gripping device comprises a hold-down section which can be placed flatly from above onto the material web which is positioned on the blade table. This hold-down section presses with a sufficiently dimensioned force onto the material web and presses the latter against the blade table, with the result that it is, as it were, clamped in immovably between the hold-down section and the blade table. That is to say, the front (in the transport direction), leading, free end of the material web lies on the blade table and is fixed positionally via the hold-down section. At least one magnetically couplable element is necessarily situated in the region of this front end; the strip is intended to be severed at this front end.

Furthermore, a magnetic element is arranged on the gripping device itself, which magnetic element interacts magnetically with a magnetically couplable element which is provided in the region of the leading end. Corresponding fixing of the front web end is possible via this magnetic interaction, as long as synchronized transport is also intended to be assisted with the use of the gripping device. Via this, however, the fixing of the cut strip is at least possible, with the result that it is fixed magnetically on the gripping device or on the underside of the hold-down, and can subsequently be moved and transported away via the movable gripping device.

As described, the gripping device lies on the upper side of the material web, so as to reach flatly over its front edge or its front end. In order that the material web is fixed over a sufficient length, as viewed in the transport direction, the hold-down section also has a corresponding length, as viewed in the web transport direction, that is to say it reaches over the material web, as viewed from its front edge, over a length of several centimeters, for example from 4 to 8 cm, in the case of a corresponding width which is greater than the width of the web material. In order that a correspondingly narrow strip with a width (as viewed in the conveying direction of the material web) of a few millimeters, for example of from 8 to 15 mm, is then possible despite the large-area fixing via the hold-down section, according to the invention in accordance with the first alternative the hold-down section has a recess, through which the cutting blade can be moved to the blade table into the cutting position. That is to say, the cutting blade cuts through the hold-down section. Since, however, the hold-down section fixes and holds down the material web both in the region directly at the web end and also, adjoining the recess, in the following web region, it is therefore ensured that no relative movement at all on the part of the material web and the cut strip occurs both during the cutting operation, that is to say when the cutting blade cuts into the material web through the recess, and during pulling out of the cutting blade after the cutting operation. This is because there is corresponding fixing of the material web both in front of and behind the actual cutting line. Therefore, the cutting device according to the invention also makes it possible to cut extremely narrow strips, since, according to the invention, cutting is carried out through the hold-down section, with simultaneous two-sided fixing of the web material in front of and behind the cutting line.

In accordance with the second alternative according to the invention, the strip is held down not only by way of the gripping device, but rather additionally by way of at least one hold-down element which, just like the gripping device, is placed onto the material web. The hold-down element is arranged in front of the gripping device, as viewed in the transport direction, that is to say lies on the material web in front of the gripping device for the cutting operation. There is a spacing, that is to say a clearance, between the hold-down element and the gripping device. The cutting blade then moves into this clearance, in order to cut off the strip. The gripping device therefore does not have a recess here; rather, the reach-through region, through which the cutting blade is guided, is defined and delimited via the further hold-down element. In the case of this alternative, the material web is therefore also fixed in front of and behind the cutting blade. This embodiment according to the invention allows the holding down of the material web to be of variable design, since the gripping device including the hold-down section and the hold-down element can be actuated separately and, as a consequence, can also be raised up again from the material web, in particular, either in a temporally synchronous or temporally staggered manner. The cutting blade can likewise also be moved in a manner which is decoupled from the gripping device and the hold-down element, which allows, for example, the cutting blade to still be left in the cutting position, while the gripping device is raised and takes the strip with it, and while the hold-down element is still seated on the material web.

This second alternative embodiment is advantageous, in particular, when a greatly adhesive material web is concerned. If a greatly adhesive material web of this type is processed only by way of the gripping device of the first alternative, it can occur that the material web adheres in a relatively great manner to the gripping device or the hold-down section which has the recess, with the result that not only the cut strip is raised, but rather also the edge of the material web which also adheres to the hold-down section. It can also occur that, when the cutting blade is moved up out of the cutting position after the cutting operation and before the raising of the gripping device, the strip and the material web can immediately adhere on one another again on account of the high adhesiveness of the material, which further impedes the raising of the strip. This can be avoided by way of the second alternative. This is because, by virtue of the fact that the holding down takes place by way of two separate elements, namely the gripping device or its hold-down section firstly and the upstream hold-down element secondly, the raising can take place after the cutting operation in such a way that the hold-down element still rests briefly in a lowered manner on the material web edge while the gripping device is raised. Since the gripping device does not reach as far as beyond the material web, only the strip can thus be raised, without the material web edge being moved with it. It is also possible that the cutting blade still remains in the cutting position until raising of the gripping device, and provides a separating plane, via which the strip and the material web edge are separated, with the result that the two cannot adhere to one another. Only after the gripping device is raised and the strip is removed, possibly even only to a minimum extent, from the material web edge, can the cutting blade be moved upward and can the hold-down element be raised from the material web.

Furthermore, as described, the gripping device can be moved relative to the blade table, that is to say can be moved both toward the latter, in order to fix the material web and, as it were, to receive the cut strip after the cutting operation, and can also be moved away from the blade table, in order to remove the strip. Since the hold-down section is also provided on the gripping device, a highly compact unit is accordingly provided which serves both for fixing for the cutting operation and for receiving and removing of the cut strip which is fixed on the hold-down section via the magnetic interaction of the magnetic element with the strip-side element. That is to say, the gripping device is given a dual function, namely firstly the sole or partial web fixing, but secondly also the gripping or receiving and removing of the strip. As a consequence, the cutting device itself combines the coupling of the material web and, resulting from this, of the cut strip to the gripping device with the actual cutting operation, with the result that there is already the fixing of the cut strip by the magnetic element on the hold-down section directly after ending of the cutting operation and, as a consequence, the removal can take place directly after the cutting operation. This is because receiving, taking place only after the cutting operation, of the cut strip is especially not required here, since the strip is connected magnetically to the gripping device at the time of its production, that is to say at the cutting time.

For the individual movements of the movable components such as cutting blade, gripping device, hold-down element, etc., corresponding actuating means for the respective movement are of course provided, in particular actuating cylinders which operate pneumatically, hydraulically or electrically and via which highly precise actuating paths can be followed. The magnetic element can be, for example, a bar, on which one or a plurality of permanent magnets is/are arranged.

According to the invention in accordance with the first alternative, as described, the hold-down section is provided with a recess, through which the blade cuts. In order firstly for the bearing area of the hold-down section on the material web to not be of excessively great configuration, and in order secondly for best possible fixing to nevertheless be achieved in the region of the cutting line, it is expedient if the recess is configured as an elongate slot. As viewed in the direction perpendicularly with respect to the web transport direction, this elongate slot of course has a length which is greater than the web width, since the cutting blade is after all also wider than the material web. The slot width, as viewed in the web transport direction, is as narrow as possible, since the cutting blade itself is very narrow. Depending on the thickness of the cutting blade, a slot width of, for example, from 5 to 15 mm is sufficient. If, in particular, the cutting blade (which will still be described in greater detail in the following text) has an adjustable cutting angle (which will still be described in greater detail in the following text), a somewhat greater slot width can be selected. This also applies in relation to the second alternative, in accordance with which a clearance, that is to say a spacing, is produced between the hold-down element and the gripping device or its hold-down section. This clearance is also expediently designed as a narrow slot which runs transversely with respect to the web longitudinal direction, with the result that it is also ensured here that the material is fixed close to the actual cutting plane.

One of the central elements of the cutting device is the gripping device. The latter can comprise a housing with a bottom and a hold-down plate which is arranged on the housing or on the bottom side, the hold-down plate and at least one section of the bottom forming the hold-down section. The hold-down plate and the bottom section are, as far as their exposed underside which forms the hold-down section is concerned, flush with one another, that is to say run in one plane. As an alternative, it is conceivable in a simpler embodiment for, instead of a housing, only a simpler plate-shaped carrier to be provided, on which, in a similar manner to on the housing, the magnetic element is arranged. If it is expedient for manufacturing reasons, a hold-down plate can be arranged on the carrier, the hold-down plate and at least one carrier section also forming the hold-down section in this case, the underside of the hold-down plate also again being flush-mounted with the carrier underside here. As an alternative, however, it is also conceivable for only a carrier to be provided which is provided with the recess or the slot, that is to say for no additional hold-down plate to be provided. In this case, accordingly, only a corresponding carrier section forms the hold-down section. Furthermore, the underside of the housing or of the bottom or of the carrier itself can also form the hold-down section, in particular with regard to the second alternative. That is to say, a separate hold-down plate does not have to be provided here, but can be provided. Here, the clearance is then therefore configured directly between the hold-down element and the housing or bottom or carrier.

If a hold-down plate is provided, the recess, in particular the slot, is expediently provided between the hold-down plate and the housing or the carrier. That is to say, the hold-down plate as it were merely extends the housing or the carrier, with the result that the gripping device has a correspondingly large overlapping section which lies on the material web.

One advantageous development of the invention with regard to the two alternatives provides that the magnetic element interacts with the magnetically couplable element through the bottom or the carrier. As described, the bottom or carrier section reaches over the strip region to be cut at the leading web end, that is to say the magnetically couplable element is arranged below the bottom or carrier section. The magnetic element is then expediently arranged in such a way that it interacts with the element through the bottom or the carrier, and therefore as a consequence attaches this element magnetically. Large-area support which distributes the pressing force as satisfactorily as possible is ensured by virtue of the fact that the bottom or carrier section is closed in the support region. At the same time however, there is also highly close positioning with respect to the element by virtue of the fact that the magnetic element is arranged above the strip-side element and acts through the bottom or carrier, which highly close positioning allows secure magnetic fixing. That is to say, the magnetic element is arranged as far as possible directly vertically above the strip-side element, in order to avoid lateral magnetic forces which exert a transverse pull on the element acting between the magnetic element and the strip-side element. At least the bottom or the carriers is/are made from a corresponding material which conducts the magnetic flux, with the result that the magnetic element can couple to the strip-side element.

A projection which forms a run-on edge for the material web can be provided on that side of the bottom or of the carrier which faces the blade table. If the gripping device is lowered onto the web material, slight raising of the web material edge which has not yet been fixed can occur, since the magnetic element is arranged on the gripping device, that is to say this web material edge is pulled in the direction of the gripping device. The projection stops the web movement.

In one expedient embodiment of the invention, the magnetic element is arranged on or in the housing or on the carrier such that it can be moved between a raised and a lowered position, in which it interacts magnetically with the element. That is to say, the magnetic element can be moved in a defined manner between two positions, with the result that it can be moved in a targeted manner into a lowered position, in which it interacts magnetically with the strip-side element in an especially defined and intentional manner. To this end, the magnetic element is preferably mounted pivotably on the housing or on the carrier, that is to say can be moved between a pivoted-up rest position and a pivoted-down coupling position. A corresponding actuating means, for example a pneumatically, hydraulically or electrically operating actuating cylinder, is also used here for the movement.

In the case of the second alternative, the movable hold-down element is also provided, as stated, in addition to the hold-down section on the gripping device. In order for it to be possible for this hold-down element to be adjusted between the raised non-working position and the working position, in which it is lowered onto the material web, the hold-down element can expediently be moved in a linear or pivotable manner relative to the material web by means of a movement device. It can therefore be moved in a linear manner, for example, in a vertical movement, or can be pivoted by a pivoting angle about a pivot axis. The respective actuating movement can be relatively small, since it is merely necessary for the hold-down element to be raised to such an extent that the material web can be delivered for the next cycle. Raising, for example, by a distance of, for example, from 0.5 to 3 cm or pivoting by, for example, from 3° to 15° is sufficient.

The hold-down element itself can be a bar which can be moved in a linear or pivotable manner or a pivotable flap. Both make secure holding down of the material web possible, since they of course extend over the entire web width. It is also conceivable, for example in the case of relatively wide material webs, for two or more bars or flaps to be arranged next to one another and possibly spaced apart somewhat from one another, in order to reduce the contact area, such that it would be sufficient for holding down if the material web is held merely locally at several points.

It is expedient here if the bar or the flap can be placed with an edge onto the material web. As a consequence, there is only a narrow contact line between the edge and the material web, which is sufficient for holding down and at the same time ensures that the material web does not adhere to the hold-down element. Furthermore, the hold-down element can consist of a material which has a reduced adhesion with respect to the web material, for example a non-stick plastic, or can be covered with a coating of this type. This also otherwise applies to the hold-down section of the gripping device, also with regard to the first alternative.

The cutting blade itself can be an ultrasonic cutting blade or a heatable cutting blade. A heated cutting blade is advantageous, in particular, for cutting highly adhesive material, since the cutting force is decreased by way of heating and, as a result, adhering to the cutting base, in particular in the case of highly adhesive material, can be avoided.

It can be provided in one development of the invention that the cutting blade is arranged on a blade carrier which is arranged in a holder such that it can be moved in a linear manner. A defined, linear cutting blade movement is ensured via this linear guidance of the blade carrier on the holder. This cutting blade movement also takes place via a correspondingly actuable actuating means such as a pneumatically, hydraulically or electrically operating actuating cylinder.

The position of the cutting blade or its linear movability can be such that the cutting blade can be placed only vertically from above onto the plane of the material web. That is to say, only a cutting operation with a right-angled cutting edge is possible. If another cutting angle is desired, a correspondingly different angular position and therefore direction of the linear movement is necessary. That is to say, the corresponding cutting angle or the arrangement of the cutting blade relative to the material web is fixed and unalterable. In contrast, however, one advantageous embodiment of the invention is provides that the holder, on which the cutting blade is arranged via the blade carrier, can be pivoted relative to the device frame about a horizontally running pivot axis, perpendicularly with respect to the web longitudinal direction of the web material. Accordingly, as a consequence, the holder and, with it, the cutting blade can be pivoted about a horizontal axis, with the result that the cutting angle can be adjusted, for example, between a vertical cutting operation with a 90° cutting edge and an angular cutting operation with, for example, a 45° cutting edge. This makes it possible for the user to set different cutting angles as required, the cutting line always running perpendicularly with respect to the web longitudinal direction in this case.

In this context, however, it is also conceivable for not only the cutting angle at the actual cutting edge to be adjusted. Rather, it is fundamentally also possible for the angle of the cutting line which the latter assumes with respect to the web longitudinal direction to be varied, and consequently therefore for the cutting blade to be pivoted about a vertical axis, with the result that a cutting line at an angle which does not equal 90° with respect to the web longitudinal direction is possible. To this end, however, it is necessary for not only the cutting blade or the corresponding holder to be pivoted about the vertical axis, but rather also the downstream periphery comprising the gripping device, since then of course the cut strip runs at a corresponding cutting angle with respect to the web longitudinal axis.

If, as described, the holder can be pivoted about a horizontal pivot axis, the pivot axis should preferably coincide with a cutting line which lies in the plane of the blade table and is defined via the cutting edge of the cutting blade in the cutting position. That is to say, the cutting edge of the cutting blade accordingly always strikes one and the same cutting line on the blade table independently of the cutting angle which is set. It goes without saying that the “coinciding” also includes slight, usually tolerance-induced deviations, that is to say a common cutting line is realized fundamentally independently of the cutting angle.

As stated in the preceding text, the gripping device can be moved relative to the blade table, in order firstly to deposit it onto the material web for holding down and to couple the magnetic element to the strip-side element, and secondly to move and to transport the magnetically fixed cut strip. To this end, it is provided in accordance with one specification of the invention that the gripping device is arranged on a movement device which can be moved both vertically and horizontally relative to the blade table. This movement direction which will also be described in the following text in detail and in different design variants is fundamentally responsible for the vertical movement of the gripping device, that is to say the lowering and lifting movement of the gripping device, and also for the horizontal movement of the gripping device or the movement of the gripping device in a horizontal plane, for example in order to move the gripping device into a depositing position, in which the cut strip is deposited, or, for example if the gripping device is also used within the context of the synchronized web advance, to move it horizontally to this end. That is to say, a plurality of degrees of freedom of movement, namely in the vertical and horizontal direction or plane, are made available via this movement device.

One particularly advantageous development of the invention provides that the movement device is configured for the vertical and horizontal movement along respective linear axes and for the horizontal movement by way of a rotation about a vertical axis. That is to say, firstly a vertical degree of freedom of movement is realized by virtue of the fact that a linear axial movement is realized via corresponding elements of the movement device. A horizontal movement along at least one horizontal linear axis which is realized via corresponding elements is likewise provided. That is to say, linear lifting and moving movements take place via this. In addition to these linear movements, however, a rotational movement is also provided, that is to say the movement device has corresponding elements which make a rotation of the gripping device about a vertical axis possible, with the result that the gripping device can be pivoted in a horizontal plane. That is to say, it can be pivoted away from the blade table and toward the blade table by way of this rotation, while the vertical and horizontal linear axes make a corresponding linear movement of the gripping device away from and toward the blade table possible.

In particular, the realization of the rotational movement on the part of the movement device makes it possible with a particular advantage for not only one gripping device to be provided, but rather two gripping devices which are arranged rotated by 180° and adjacently with respect to one another, which gripping devices can be rotated together and simultaneously in each case toward the cutting apparatus and away from the latter by way of a rotation on the part of the movement device. The two gripping devices are therefore oriented in an opposed manner with respect to one another, as viewed in the web transport direction. While the one gripping device is positioned adjacently with respect to the cutting apparatus and a cut strip can be received on this gripping apparatus, the second gripping device is positioned so as to face away from the cutting apparatus and moves a cut strip to a depositing position. That is to say, the one gripping device receives a strip, while the other gripping device deposits a strip. This makes a spectacular increase in the throughput possible, since receiving of a cut strip and depositing of a previously cut strip can ultimately take place simultaneously in a common working cycle. It is conceivable in this context that the two gripping devices can be moved correspondingly vertically and/or horizontally via corresponding linear guides in each case separately or independently of one another, with the result that the individual gripping devices can carry out movements which are independent in terms of synchronization from one another within one work cycle, by the one gripping device interacting with the material web and the other bringing about the depositing of a cut strip. These linear, independent movements are also brought about by corresponding actuating means such as suitable pneumatic, hydraulic or electric actuating cylinders which can be actuated correspondingly.

In order to attach the working unit comprising the movement device and the one or the two gripping devices to the device frame and at the same time, via this, to realize a first linear horizontal degree of freedom of movement, the invention further provides that the movement device comprises a slide, via which it is arranged in a horizontally movable manner on a linear guide which is provided on the device frame. Accordingly, the entire construction, arranged on this slide, of the following components of the movement device including the gripping device or devices can be moved horizontally, via this slide guide on the device frame, relative to the device frame and the blade table which is arranged in a positionally fixed manner on it. This movement also expediently takes place via an actuating means, in particular in the form of a pneumatically, hydraulically or electrically operating actuating cylinder. The actuating movement is relatively short; it is merely a few centimeters. It can serve, in particular, to realize a synchronized web advance by means of the gripping device or to incorporate the gripping device into this. To this end, the gripping device is placed onto the material web end which is to be moved into the cutting position, and the gripping device including the web material is then moved in a linear manner by the corresponding section width, that is to say, for example, approximately from 8 to 15 mm, by way of displacement of the slide, and the web end is moved into the cutting position, in which it is then fixed on the blade block via the gripping device.

In order to realize a linear vertical degree of freedom of movement, a holder can be arranged on the slide such that it can be moved vertically, to which holder the gripping device is coupled or the two gripping devices are coupled. Here too, a suitable linear guide is once again provided on the slide, on which linear guide the holder is arranged such that it can be moved vertically. The holder as part of the movement device is coupled in terms of movement to the gripping device or devices; that is to say, in the case of a vertical holder movement, the gripping device or the two gripping devices are necessarily also moved vertically. The holder is also expediently moved by means of an actuating element in the form of a pneumatically, hydraulically or electrically operating actuating cylinder.

In order for this vertical movement to be realized in a simple way, a pivoting lever which is mounted pivotably on the slide and can be moved via an actuating element, for example the above-described actuating cylinder, can be provided, which pivoting lever is coupled to the holder. A transmission ratio can be realized via this lever arrangement. This is expedient, since the vertical stroke which the gripping device or the two gripping devices is/are ultimately intended to perform via this can be relatively small; it lies in the range of a few millimeters, for example from 2 to 4 mm. Since most of the weight of the movement device together with the gripping device or devices is supported via the pivot point of the pivoting lever, a gentle up and down movement can be achieved via this.

In order to also make an independent, direct movement of the one or the two gripping devices possible, one expedient embodiment of the invention provides that the movement device comprises a mounting plate, on which the one or the two gripping devices is/are arranged in each case in a linearly movable manner along a horizontal axis and/or along a vertical axis. Accordingly, this mounting plate forms a mounting interface, on which the one or the two gripping devices can be assembled. Relative to this mounting plate, the or each gripping device can be moved in a linear manner either only along a vertical axis, along a horizontal axis or along both. That is to say, additional degrees of freedom of movement can be realized via this, possibly in addition to the above-described movement capabilities along the horizontal and the vertical axis. These are expedient, in particular, when two gripping devices are provided, since, as described above, they allow different, separate movements to be carried out with different cycle times.

One development of this concept of the invention provides that the gripping device or in each case one gripping device is arranged on a vertical actuating device which is arranged on a horizontal linear guide on the mounting plate. This vertical actuating device and horizontal linear guide are also part of the movement device. Once again, the vertical adjustment and the horizontal adjustment can take place via corresponding actuating elements such as pneumatically, hydraulically or electrically operating actuating cylinders, the vertical and horizontal movement of course being independent of one another.

If a rotational movement is additionally provided on the part of the movement device, which rotational movement is already expedient in the case of only one gripping device, but is of particular advantage in the case of two gripping devices, in particular, a rotary drive is expediently provided to this end, which rotary drive is coupled to the gripping device or the two gripping devices. That is to say, the one or the two gripping devices can be pivoted in the horizontal plane via this rotary drive. This rotary drive can be arranged on the holder which, as described above, is arranged via a vertical linear guide on the horizontally movable slide. That is to say, the rotary drive is also raised vertically via the holder, and, with the rotary drive, the gripping device which is coupled to it or the two gripping devices is/are of course also raised. It is conceivable here that the rotary drive is connected directly via a corresponding connection to the mounting plate. That is to say, the mounting plate is attached, for example, to a corresponding mounting flange of the output shaft of the rotary drive, with the result that the entire construction consisting of the mounting plate and gripping device/devices is seated on the rotational device.

Overall, accordingly, the different design variants make it possible to realize a plurality of different degrees of freedom of movement which can be actuated separately, both in the form of linear movements and also a rotational movement, these degrees of freedom of movement including, by way of the linear movement, either large parts of the movement device or of the corresponding gripping and transport construction, or only individually one gripping device or the respective gripping device.

In order to cut a strip, the material web has to be advanced synchronously by the respective strip width, that is to say has to be transported into the region of the cutting apparatus. To this end, a transport means, in particular a transport belt, can be provided on the device frame for transporting the material web to the cutting apparatus. Accordingly, this transport means is part of the cutting device; via the transport means, the synchronized advance takes place by the small advancing length in a manner which corresponds to the strip width. A transport belt is preferably used which expediently consists of a material which has only low adhesion to the material web, with the result that the latter adheres as little as possible to it.

In accordance with one particularly advantageous development, it can be provided that the movement of the transport means and a horizontal movement of the movement device, during which the gripping device is seated on the web material and the magnetic element interacts with the magnetically couplable element, are synchronized for transporting the web material into the cutting position. As has already been stated in the preceding text, there is the optional possibility of integrating a gripping device into the synchronized web advance. To this end, after a cutting operation has taken place and removal of the cut strip, the gripping device is moved again into a position above the web end which is not yet situated in the actual cutting position. The gripping device is lowered, and the magnetic element couples to the web-side element which is situated directly below it. Subsequently, the gripping device is raised vertically slightly, and firstly the transport belt is moved in a synchronized manner in the transport direction, and at the same time the gripping device is also moved in the transport direction via the movement device. The two movements, that is to say that of the transport belt and of the gripping device, are synchronized, with the result that they both cover exactly the same distance. The movement ends when the leading web edge has reached the end position, after which the gripping device is lowered and deposits the web end on the blade table and at the same time fixes it. This ensures an exact transport movement and positioning of the web end.

Different embodiments are conceivable for the movement of the transport means. To this end, firstly, a corresponding drive motor which drives a drive roller, over which the preferably belt-shaped transport means runs, can be provided. This drive motor is synchronized with the corresponding actuating element for the horizontal movement of the slide, via which the movement of the gripping device takes place. As an alternative, in order to move the transport means, a clamping means which acts releasably on it and can be moved in a linear manner can be provided. The operation of this clamping means which can be moved horizontally in both directions, for example, via a corresponding actuating cylinder is of course also synchronized with the actuating operation of the slide.

In order to prevent it being possible for the material web which lies on the transport means to slip, it is expedient if one or more magnetic means which interact magnetically with the elements of the material web is/are provided below the upper run of the transport means. That is to say, these magnetic means couple magnetically to the web elements and fix them on the transport belt, with the result that the material web is secured against slipping.

Furthermore, a transfer table which can be raised and lowered and guides the material web can be provided between the end of the transport means and the blade table. Since the transport means is a circulating transport means, preferably, as described, a transport belt, a gap arises between the end of the transport means and the blade table. This gap is bridged by means of a transfer table. Here, the transfer table can be raised and lowered, in order that a smooth transfer of the web to the blade table is possible. This is because, within the context of this transfer, the end of the material web can be raised and conveyed via the gripping device, as stated. This raising and lowering movement can be assisted via the transfer table. Here, the transfer table is expediently coupled to a movement on the part of the movement device, in particular the vertical movement of the holder, within the context of which the gripping device can be raised and lowered, after this movement serves to raise the gripping device for the subsequent web transport into the cutting position. This coupling can take place purely mechanically, for example, via a lever arrangement or via a driver arm and a slotted guide or the like. As an alternative, the transfer table can of course also have a dedicated actuating element such as an actuating cylinder. Here, the table movement can be limited in both directions by way of stops.

It is expedient if the transfer table is provided with a sliding liner or sliding coating, that is to say a non-stick coating, since the material web is pulled over it.

The transfer table is preferably mounted pivotably and can be raised and lowered with the end which is adjacent with respect to the blade table. That is to say, the transfer table can be adjusted as it were in a ramp-like manner, with the result that the material web can be pulled into a defined, raised position.

In order to enable a transition which is as free from gaps as possible from the transfer table to the blade table, it is conceivable for a chamfer to be provided on the transfer table at the end which is adjacent with respect to the blade table, which chamfer is arranged adjacently with respect to a dimensionally compatible chamfer on the blade table in the lowered position.

Furthermore, a recess for receiving a section of the gripping device, in particular a projection which is provided on its underside, can be provided on the upper side of the blade table in the region of the end which faces away from the cutting apparatus.

The blade table itself preferably comprises a liner which is made, in particular, from plastic and forms its upper side which supports the web material. This liner is also preferably made from a material which exhibits as low as possible a tendency to adhesion with respect to the material web. If provided, the above-described chamfer and/or the recess are/is configured on this liner.

In addition to the cutting device itself, the invention relates, furthermore, to an apparatus for producing and processing strips of a material web, of which strips each contains at least one magnetically couplable element, comprising a cutting device of the above-described type and a receiving device which is connected downstream of this cutting device for receiving the separated strips on a carrier.

The receiving device accepts a strip which is fed by the gripping device on a suitable carrier, in particular a corresponding sheet, that is to say a flexible carrier means which is suitable, in particular, for winding up, in order to configure a corresponding wound reel which can be processed further subsequently in a downstream processing device, and the individual cut strips with the elements or RFID chips can be unwound again, removed and introduced into tires in a corresponding processing device, for example a tire building machine.

It is conceivable here that, in the receiving device, the carrier which is occupied by the strip is covered by way of a further carrier, that is to say a second sheet, with the result that the strips are arranged between the two carriers. This second carrier or sheet is not mandatory, however.

Furthermore, the receiving device can comprise a winding device, or a winding device can be connected downstream of this receiving device, in which winding device the carrier or carriers occupied by the strips is/are wound, as has already been described, to form a reel.

Further advantages and particulars of the present invention arise out of the exemplary embodiment described in the following and also from the associated drawings.

### BRIEF DESCRIPTION OF THE DRAWING

In the drawing:

FIG. 1 shows an outline illustration to explain the function of a cutting device according to the invention and an apparatus according to the invention,

FIG. 2 shows the arrangement from FIG. 1 in a top view,

FIG. 3 shows a more detailed side view of the arrangement from FIG. 1,

FIG. 4 shows a top view of the arrangement from FIG. 3,

FIG. 5 shows a side view of the cutting device according to the invention,

FIG. 6 shows a top view of the cutting device from FIG. 5,

FIG. 7 shows a detailed view of a part of the movement device with a slide and an advancing/clamping device attached to it,

FIG. 8 shows a detailed view of a part of the movement device with a holder, a rotary drive, mounting plate and two gripping devices,

FIG. 9 shows the arrangement from FIG. 8 with a vertically and horizontally displaced gripping device,

FIG. 10 shows the arrangement from FIG. 9 with a hidden gripping device, the gripping device which is shown being raised vertically,

FIG. 11 shows an enlarged detailed view of a gripping device with a lowered magnetic element,

FIG. 12 shows the gripping device from FIG. 11 with a raised magnetic element,

FIG. 13 shows a perspective view of the cutting apparatus with a raised blade,

FIG. 14 shows the cutting apparatus from FIG. 13 with a lowered blade,

FIG. 15 shows the cutting apparatus in a pivoted position,

FIG. 16-24 show different part illustrations as outline illustrations to explain the function of the cutting device within the context of the synchronized transport of the material web, the cutting operation and the receiving and removing of a cut strip,

FIGS. 25-35 show different part outline views of the apparatus according to the invention together with a cutting device according to the invention comprising two gripping devices to explain the method of operation of the cutting apparatus or apparatus over a complete work cycle, the cycle following the work sequence shown in FIGS. 16-24,

FIG. 36 shows an outline illustration to explain the function of a cutting device according to the invention and an apparatus according to the invention in a second embodiment,

FIG. 37 shows the arrangement from FIG. 36 in a top view,

FIG. 38 shows a more detailed side view of the arrangement from FIG. 36,

FIG. 39 shows a top view of the arrangement from FIG. 37,

FIG. 40 shows a side view of the cutting apparatus according to the invention in the second embodiment,

FIG. 41 shows a detailed view of a part of the movement device with the holder, rotary drive, mounting plate and two gripping devices,

FIG. 42 shows an enlarged detailed view of a gripping device with a lowered magnetic element,

FIG. 43 shows the gripping device from FIG. 42 with a raised magnetic element,

FIG. 44-52 show different part illustrations as outline illustrations to explain the function of the cutting device in the second embodiment within the context of the synchronized transport of the material web, the cutting operation and the receiving and removing of a cut strip,

FIG. 53-63 show different part outline views of the apparatus according to the invention together with a cutting device according to the invention comprising two gripping devices to explain the method of operation of the cutting apparatus or apparatus over a complete work cycle, the cycle following the work sequence shown in FIGS. 44-52,

FIG. 64 shows an outline illustration of a side view of the apparatus in the second embodiment with an illustration of the movement mounting of the hold-down element, and

FIG. 65 shows a top view of the apparatus from FIG. 64.

### DETAILED DESCRIPTION OF THE INVENTION

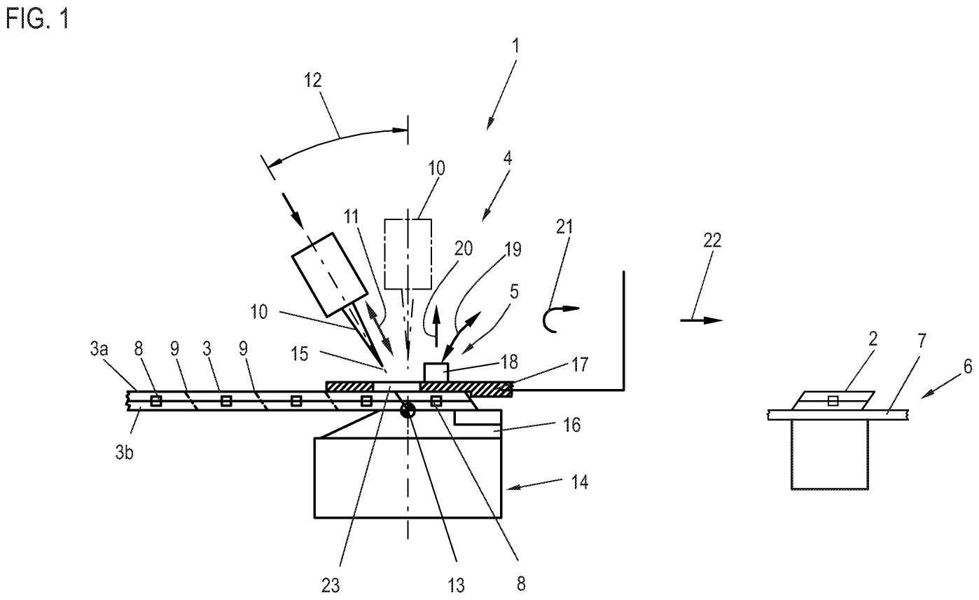

FIG. 1 shows an outline illustration of an apparatus according to the invention for producing and processing strips 2 of a material web 3 and, to this end, the apparatus 1 comprises a cutting device 4 which serves to cut off the strips 2 from the material web 3. The cutting device 4 comprises at least one gripping device 5 which, inter alia, serves to receive and to transport a cut strip 2 to a downstream receiving device 6, where the separated strips 2 are deposited on a preferably sheet-like carrier 7. The receiving device 6 can also comprise a winding device (not shown in greater detail) for winding up the filled carrier to form a reel or spool, from which the individual strips are unwound again in a downstream processing device.

The material web 3 is an endless web consisting of an upper layer 3a and a lower layer 3b made from a rubber strip and magnetically couplable elements 8, preferably RFID chips, as an alternative metal strips or magnets, which are received or embedded in between. The cutting lines 9 which run obliquely here and along which the material web 3 is cut in order to form the strips 2 are shown using dashed lines.

The cutting device 4 serves to this end, which cutting device 4 has a cutting blade 10 which, as shown by the double arrow 11, can be moved in a linear manner relative to the material web 3. As is indicated, the cutting blade 10 can be pivoted, as indicated by way of the double arrow 12, between the oblique position shown using solid lines according to FIG. 1 into a vertically upright position which is shown using dashed lines. Accordingly, the cutting angle can be varied via this. The pivoting takes place about a pivot axis 13 which preferably coincides with the cutting line on a blade table 14, on which the material web 3 lies during the cutting operation, and which is defined by way of the cutting edge 15 of the cutting blade 10 in the final cutting position. The blade table 14 has a corresponding liner 16 which is preferably made from a material which does not adhere to the material web 3 which is often adhesive.

As stated, furthermore, a gripping device 5, comprising firstly a hold-down section 17 which fixes the material web on the blade table 14 during the cutting operation, and a magnetic element 18 which couples magnetically to an element 8, situated directly below it, of the material web 3 are provided, with the result that the cut strip 2 is attached magnetically via this to the gripping device 5 or the hold-down section 17, and can be removed via the gripping device 5. The magnetic element 18, which can be a magnetic bar which comprises a plurality of individual magnets, can be pivoted, as shown by way of the double arrow 19, and can be moved out of a non-working position into a coupling position, in which it is vertically above the element 8. The gripping device 5 itself can be moved vertically in every case, as shown by way of the arrow 20. The arrow 21 indicates that the raised gripping device 5 can be rotated in a horizontal plane about a vertical axis, while the arrow 22 indicates that a horizontal movement of the gripping device 5 can also take place. The individual degrees of freedom of movement will be described in detail in the following text.

Since the strip 2 is very narrow and has, for example, only a width of between preferably 8 and 15 mm in the case of a possible length of, for example, from 70 to 80 mm, it is necessary for the material web 3 to be fixed correspondingly with its leading end on the blade table 14 during the cutting operation, with the result that it is prevented that the material web 3 moves during the cutting operation and exact, continuous cutting is not possible. Since, on account of the small width of the strips 2 to be cut, the cutting operation necessarily has to take place very close to the free end of the material web 3, but at the same time fixing over a relatively large area of the material web 3 is also necessary, the hold-down section 17 is provided with a recess 23 in the form of an elongate slot, through which the blade 10 cuts. This embodiment of the hold-down section 17 makes it possible for the material web 3 to be fixed and held down flatly in front of and behind (as viewed in the transport direction) the actual cutting line or the cutting operation, with the result that any movement at all of the material web 3 is ruled out both during plunging down and pulling out of the cutting blade 10. That is to say, the cutting blade 10 cuts through the hold-down section 17 and there is firstly secure fixing of the material web 3 here, but secondly cutting and holding down of the very narrow strip is also possible as a consequence of the cutting operation through the hold-down section 17.

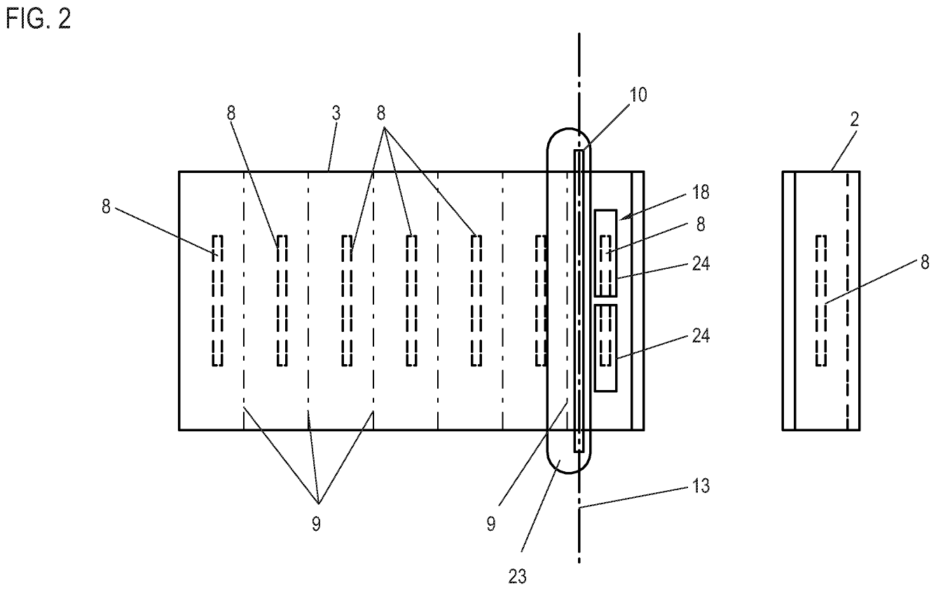

FIG. 2 shows a top view of the outline arrangement from FIG. 1. For improved illustrative purposes, the cutting blade 10 is not shown here, nor is the hold-down section 17.

The material web 3 is shown with the embedded elements 8 or RFID chips which are shown using dashed lines, the intended cutting lines 9 also being shown here.

Furthermore, the recess 23 is shown in the form of the elongate slot which is longer than the width of the material web 3, the cutting blade 10 or the cutting edge 15 of course also being wider than the material web 3. Merely the cutting blade 10 and the pivot axis 13 which, as described, coincides with the cutting line on the blade table 14 are shown in principle, the imaginary cutting line 9 on the upper side of the material web 3 being of course correspondingly offset in angular terms with respect to the cutting line since an oblique cutting operation takes place here (starting from FIG. 1).

Furthermore, the magnetic element 18 is shown which is shown here in the form of two separate individual magnets 24 and which is arranged exactly above a web-side element 8 in the coupling position.

Furthermore, the cut and removed strip 2 which has already been shown in FIG. 1 is shown, which strip 2 lies rotated by 180° with respect to the orientation of the immediately cut strip 2, since it has been moved into the depositing position via a rotational movement of the gripping device 5. The embedded element 8 is also once again shown here.

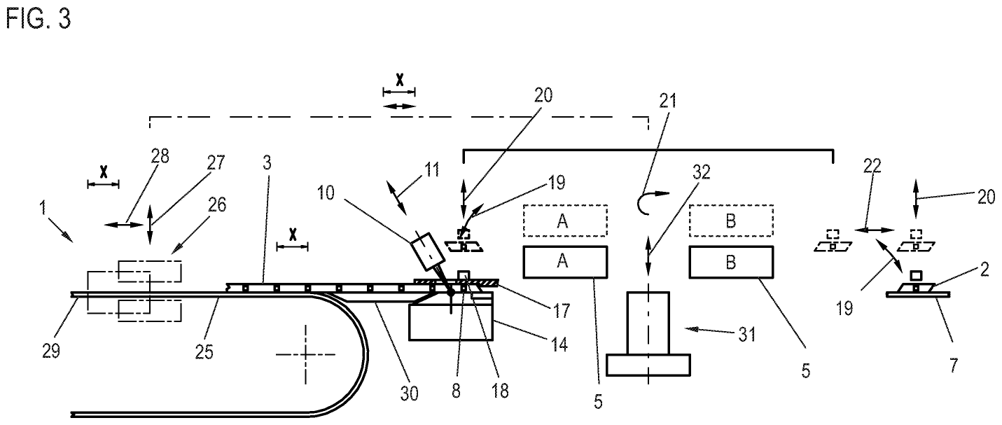

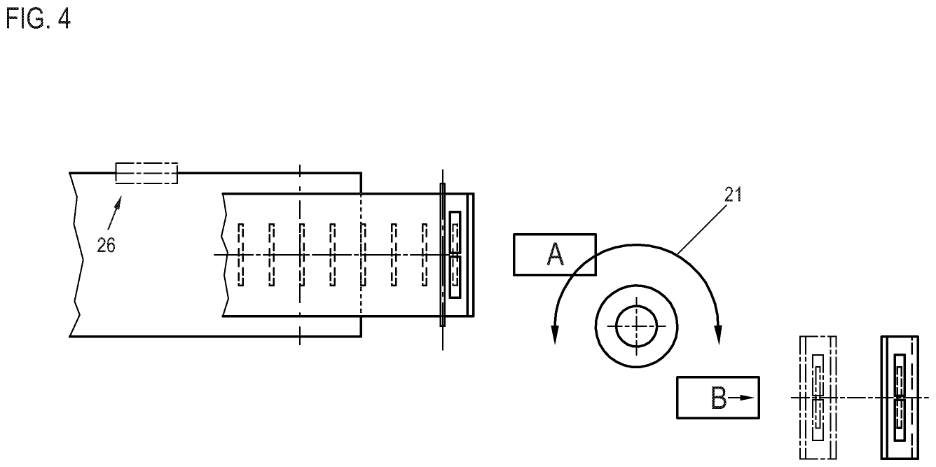

FIGS. 3 and 4 show a side and top view of a detail of the apparatus according to the invention in more detailed form, two gripping devices 5 which, as is also the case in the following text, are denoted by A and B being provided here.

The outline illustration shows the cutting device 1 which here comprises a transport means 25 in the form of a transport belt which is assigned an advancing device 26, for example a clamping unit, which (see the double arrows 27, 28) can be closed for clamping purposes and can be moved horizontally for displacing purposes. Here, this advancing device 26 is assigned to the upper run 29 of the transport means 25. The material web 3 rests on the transport means 25. The transport belt ends adjacently with respect to, but spaced apart from, the blade table 14. A transfer table 30 is provided to bridge the gap between the transport means 25 and the blade table 14, over which transfer table 30 the material web 3 is guided.

Furthermore, the cutting blade 10 is shown in principle, which cutting blade 10 is in the cutting position here and reaches through the corresponding recess 23 in the hold-down section 17. The hold-down section 17 is lowered onto the material web 3 and clamps the latter onto the blade table 14. The magnetic element 18 couples to the web-side element 8. When the cutting blade 10 is moved back, the gripping device can raise and remove the cut strip 2.

As described, two gripping devices 5 which are denoted here by A and B are provided here. They can be moved in a plurality of degrees of freedom by way of a corresponding movement device 31, as shown in principle in FIGS. 3 and 4. The two gripping devices 5 or A, B are connected to the movement device 31 and, via the latter, firstly (as shown by way of the double arrow 32) can be raised vertically and secondly (as shown by way of the arrow 21) can also be rotated by 180°, with the result that the position of the gripping devices A, B can be swapped. The gripping device B which points here in the direction of the depositing position (the same also applies to the gripping device A) can also be moved horizontally, as shown by way of the arrow 22, in order to move to the final depositing position.

The exact work sequence will be described in the following text in relation to FIG. 16 et seq.

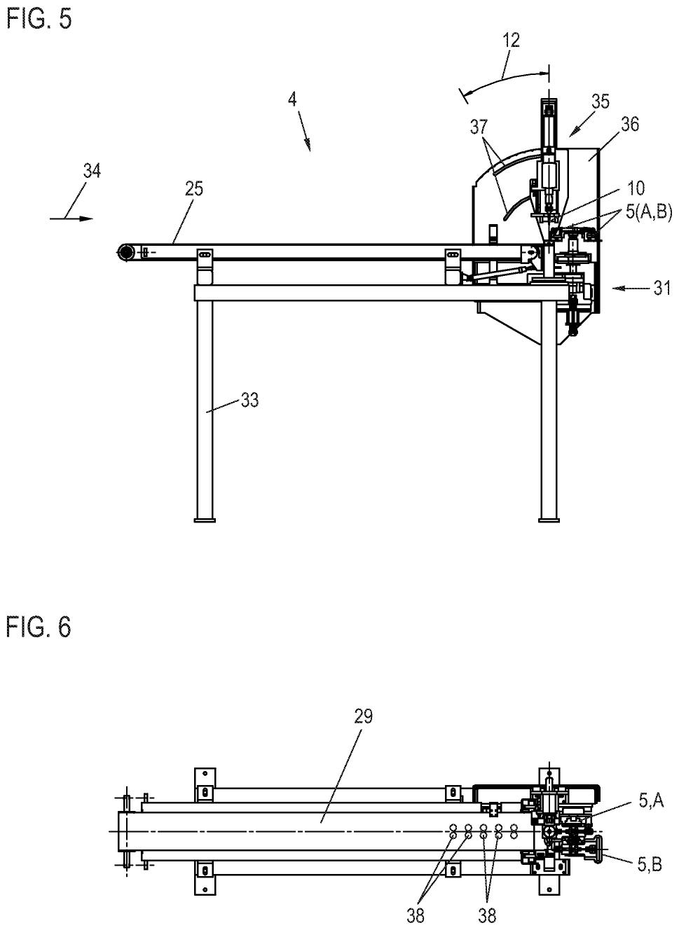

FIGS. 5 and 6 show a side view and a top view of the cutting device 4. The latter comprises a device frame 33, on which firstly the transport means 25 is arranged which conveys in the transport direction, as shown by way of the arrow 34. Furthermore, the cutting apparatus 35, comprising the cutting blade 10 and the blade table 14, and the movement device 31 and the two gripping devices 5 or A, B are arranged on the device frame 33.

As described, the cutting blade 10 can be pivoted, as indicated by way of the double arrow 12 in FIG. 1, but also in FIG. 5. To this end, the cutting apparatus 5 is guided on an attachment plate 36 which has corresponding slots 37, and can be fixed accordingly thereon at the set angle. The detailed construction of the cutting apparatus 35 will be described in the following text.

FIG. 6 shows, furthermore, magnetic means 38 which are arranged below the upper run 29 of the transport means 25, are arranged centrally in a line, and interact magnetically with the elements 8 which are likewise arranged centrally on the transport belt 3. Via these positionally fixed magnetic means 38, the material web 3 is secured against slipping on the transport means 25.

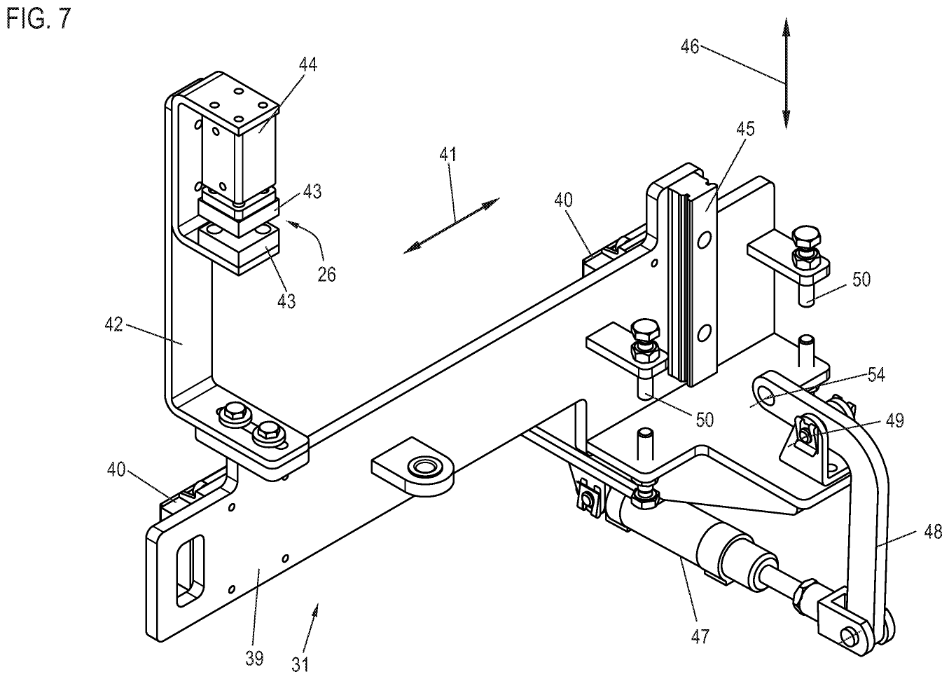

FIG. 7 shows a part of the movement device 31. The movement device 31 and, with it, the one or the two gripping devices 5 or A, B are arranged such that they can be displaced horizontally and linearly on the device frame 33. To this end, a slide 39 is provided which comprises corresponding linear guide elements 40 which are connected to a corresponding linear guide on the device frame 33, with the result that (as shown by way of the double arrow 41) the slide 39 including the entire construction can be moved horizontally thereon. This horizontal movement according to the double arrow 41 serves for the synchronized advance of the material web 3, which will be described in more detail in the following text.

FIG. 7 shows, furthermore, that the advancing device 26 which serves to advance the transport means 25 is fastened to the slide 39. Two clamping jaws 43 are arranged on a holding arm 42, between which clamping jaws 43 the transport means 25 is received, it being possible for the upper clamping jaw 43 to be moved against the lower clamping jaw 43 via an actuating cylinder 44, with the result that the transport means 25 which is situated in between is clamped. If the slide 39 then moves along the arrow 41, the transport means 25 and, with it, the material web 3 are necessarily also displaced by the cycle. After release of the clamping action, the slide 39 including the advancing device 26 can then move back again at a given time; a new advancing cycle can begin.

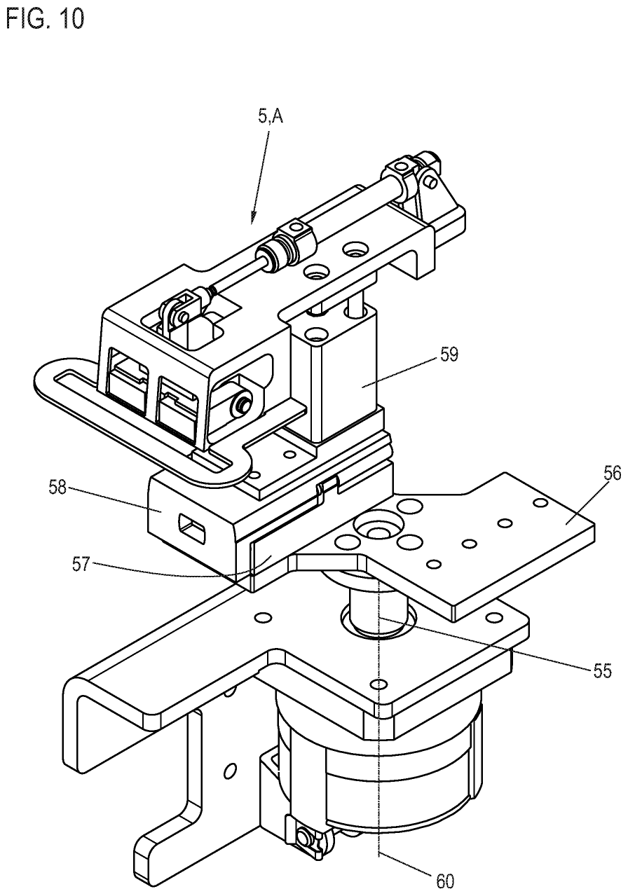

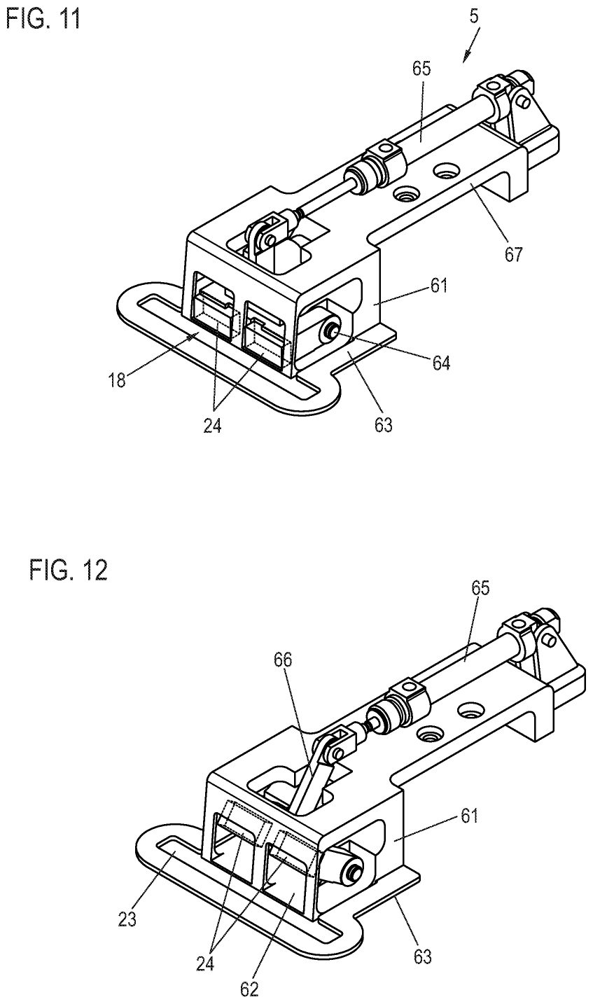

Furthermore, a vertical linear guide 45 is provided on the slide 39, on which vertical linear guide 45 a holder (will be described in the following text, see FIGS. 11-13) can be moved vertically as shown by way of the double arrow 46. A series of further operating elements are arranged on this holder which is of course likewise part of the movement device 31, which operating elements can be moved vertically via this but at the same time can also be moved horizontally via the slide 39.

An actuating element 47 in the form of a cylinder is provided for this vertical movement, which actuating element 47 is fixed with one end on the slide 39, and the other, movable end of which actuating element 47 is connected to a pivoting lever 48 which can be pivoted about a pivot axis 49. As will be described in more detail in the following text, the other end of the pivoting lever 48 is connected to the holder which is guided on the linear guide 45, with the result that pivoting of the pivoting lever 48 necessarily leads to a vertical movement of the holder. The vertical movement is limited via corresponding stops 50.

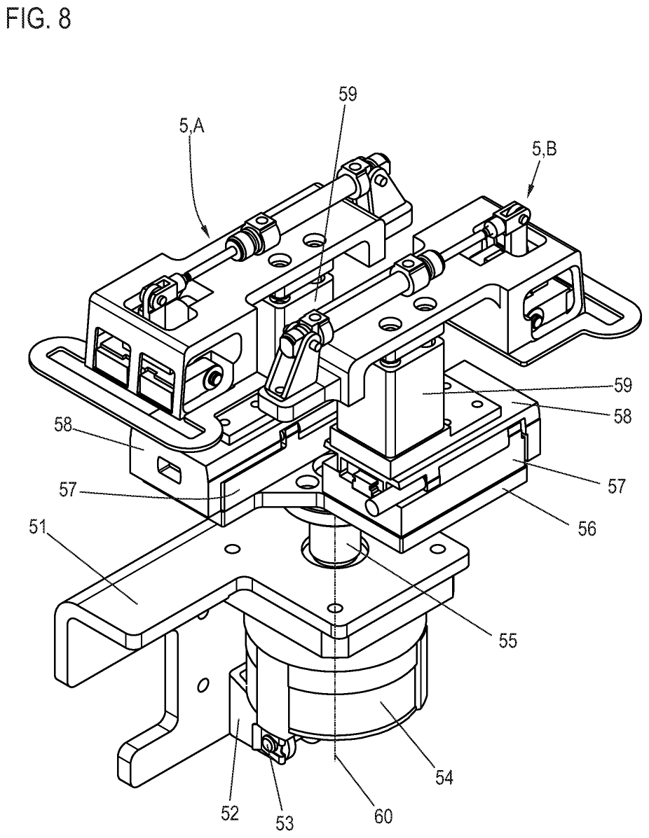

FIGS. 8-10 show the assemblies which are arranged such that they can be displaced vertically on the slide via the linear guide 45. Firstly, the above-described holder 51 is shown, on the rear side (not shown here) of which corresponding guide elements are provided which are received on the linear guide 45. A corresponding bearing block 52 is provided at the lower end of the holder 51, on which bearing block 52 a bearing pin 53 is provided which engages through a bearing socket 54 on the pivoting lever 48. In the case of pivoting of the pivoting lever 48, the holder 51 including all the attachment parts is moved vertically via this connection.

A rotary drive 54 is arranged on the holder 51, which rotary drive 54 comprises a drive shaft 55, on which (see FIG. 10) a mounting plate 56 is fastened via a suitable fastening flange. The two gripping devices 5 or A and 5 or B are installed on the mounting plate 56.

In each case one linear guide element 57 is situated on the mounting plate 56, which linear guide element 57 makes horizontal linear guidance for a horizontal advance of the respective gripping element 5 or A, B possible, the latter being received such that it can be guided in a linear manner on it via a corresponding linear guide element 58. Via this, each gripping device 5 or A, B can be separately moved horizontally.

For a corresponding vertical movement, moreover, each gripping device 5, A, B can be adjusted vertically via a vertical actuating device 59. That is to say, each gripping device 5, A, B can be raised separately and vertically, and can also be displaced horizontally.

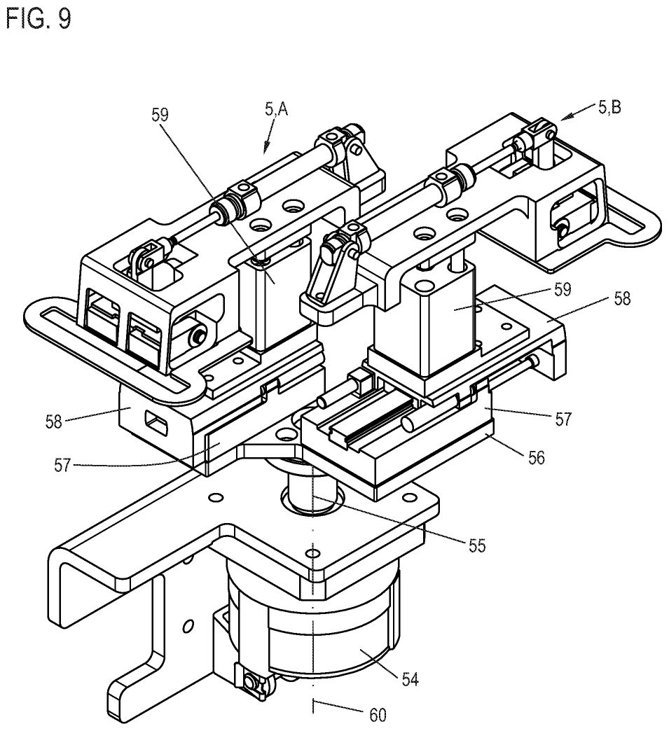

Here, FIG. 8 shows the two gripping devices 5 or A, B firstly in the vertically lowered position, and secondly in the horizontally retracted position. In FIG. 9, the gripping device B is shown firstly raised vertically, and secondly moved horizontally, whereas FIG. 10, in which only the gripping device A is shown, shows the latter merely vertically raised.

As described, the mounting plate 56 supports all the components installed on it. Since the mounting plate 56 is seated on the drive shaft 55 of the rotary drive 54, the mounting plate 56 including all the installed elements can accordingly be rotated about a vertical axis 60, as shown in FIGS. 8-10, in order to bring about the rotational movement (see double arrow 21 in FIG. 4).

FIGS. 11 and 12 show a gripping device 5 in detail, the embodiment being identical for each gripping device A, B. The gripping device 5 comprises a housing 61 with a bottom 62, a hold-down plate 63 being arranged on the housing 61 or the bottom 62 and running with its underside in a flush-mounted manner with respect to the underside of the bottom 22. The above-described recess 23 in the form of the elongate slot is configured between the housing 61 and the hold-down plate 63, through which recess 23 the cutting blade 10 performs the cutting operation. The underside of the bottom 62 and of the hold-down plate 63 form the hold-down section 17.

The magnetic element 18 (here, with the two magnets 24) is arranged in the interior of the housing such that it can be pivoted about a pivot axis 64. It can be pivoted out of a lowered coupling position according to FIG. 11, in which it can couple magnetically to the web-side element 8 (that is to say, the RFID chip), and a raised non-working position according to FIG. 12. An actuating element 65 serves to this end once again in the form of a pneumatically, hydraulically or electrically operating actuating cylinder which is coupled to a corresponding pivoting lever 66, on which the magnetic element 18 is arranged. That is to say, the magnetic element 18 can be placed as required onto the bottom 62 via this actuating element 65 and can be brought into magnetic coupling with the web-side element 8, with the result that, after the cutting operation has taken place, the strip which runs below the bottom 62 and the hold-down plate 63 can be fixed magnetically on the underside of this hold-down section 17 and can be removed by way of a movement of the gripping device 5. The underside of the bottom 62 or an underside section and the underside of the hold-down plate 63 lie flatly on the material web 3 in the hold-down position, that is to say form the actual hold-down section 17.

The housing 61 is provided with a corresponding fastening section 67, via which it can be fastened to the vertical actuating device 59 (see FIGS. 8-10).

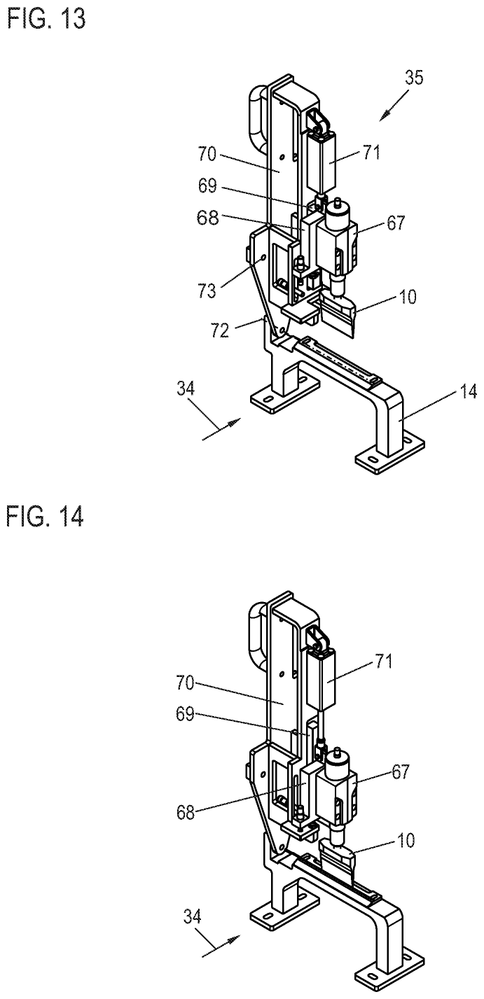

FIGS. 13-15 finally show perspective views of the cutting apparatus 35. The latter comprises the cutting blade 10 which is arranged on a blade carrier 67 which for its part is arranged such that it can be moved in a linear manner via a corresponding linear guide element 68 on a linear guide 69 of a plate-shaped holder 70. Here too, an actuating element 71 in the form of a pneumatically, hydraulically or electrically operating actuating cylinder is provided for the linear movement. Accordingly, via the actuating element 71, the cutting blade 10, which is, for example, an ultrasonic cutter, can be moved out of the raised non-working position according to FIG. 13 into the cutting position which is shown in FIG. 14.

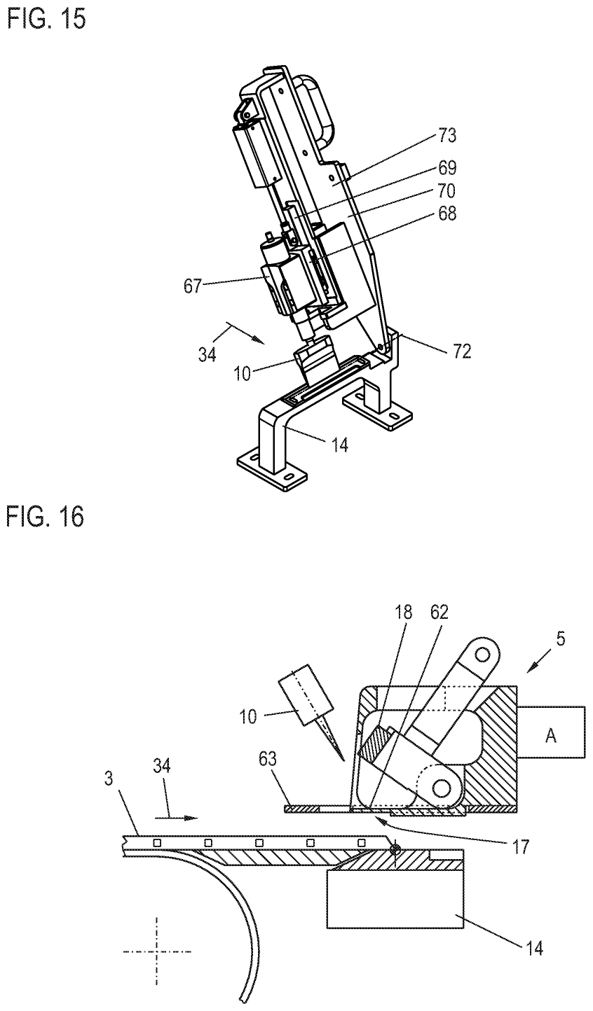

The plate-shaped holder 70 is arranged on the blade table 14 which is of yoke-like configuration here, such that it can be pivoted about a pivot axis 72 which lies horizontally and perpendicularly with respect to the web conveying direction 34. This makes the pivoting of the cutting apparatus 35 according to the double arrow 12 from FIGS. 1 and 5 possible. The fixing in the desired position takes place via suitable clamping screws which are guided through the corresponding guide grooves 37 and are screwed into corresponding bores 73 on the plate-shaped holder 70. FIG. 15 shows a pivoting position relative to the positions which are shown in FIGS. 13 and 14 and in which the cutting blade 10 lies vertically. The pivoting angle is, for example, from 45° to 90° in relation to the horizontal plane.

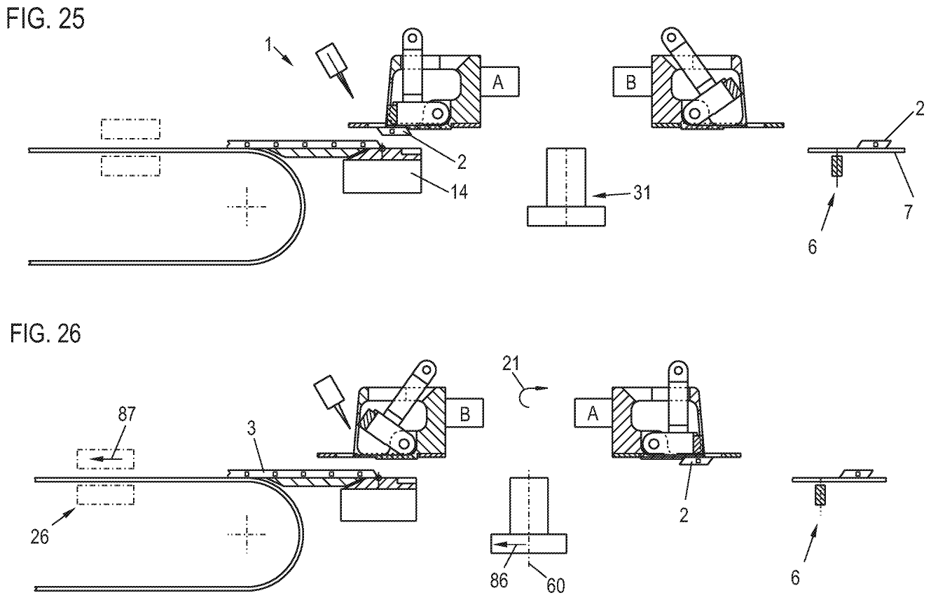

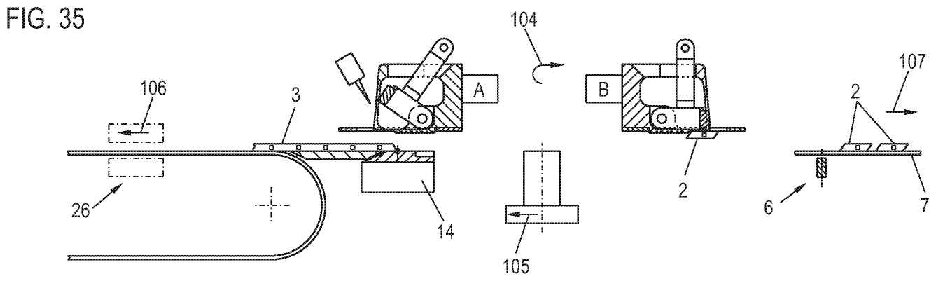

FIGS. 16-24 show corresponding outline illustrations of the method of operation of the cutting apparatus according to the invention firstly within the context of the web transport, and secondly within the context of the actual cutting operation, while the following FIGS. 25-35 illustrate the method of operation including the removal over an entire work cycle.

FIG. 16 shows the material web 3 in its position after a preceding cutting operation. As a consequence, it is not yet situated in the cutting position, into which it first of all has to be transported. The gripping device 5 which is labeled here as gripping device A, since the second gripping device B is also shown in FIG. 25 et seq., is situated in a position above the blade table 14, the hold-down section 17, formed by the underside of the hold-down plate 63 and the bottom 62, being positioned above the material web 3. The magnetic element 18 is pivoted upward, and the cutting blade 10 is at a distance from the gripping device 5, A.

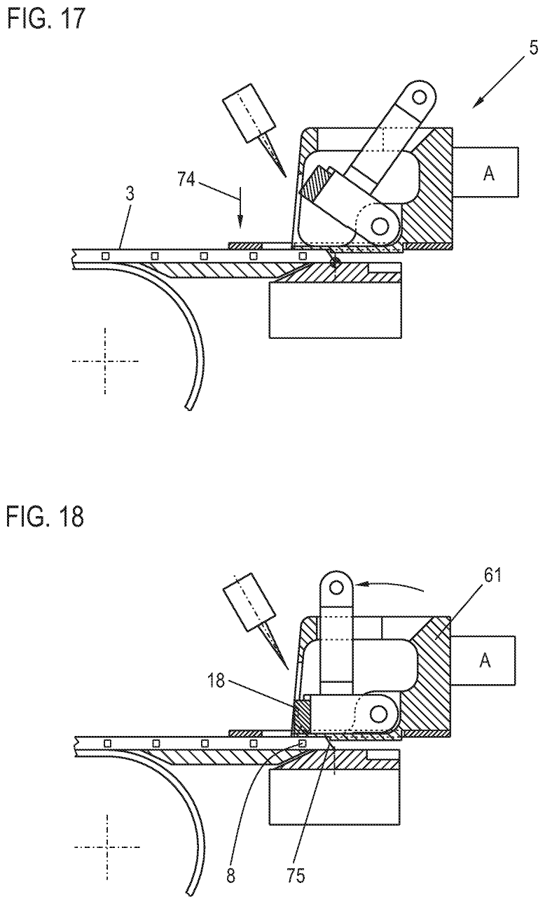

In the next step which is shown in FIG. 17, the gripping device 5, A is lowered, as shown by way of the arrow 74. The hold-down section 17 then lies on the material web 3.

In the next step which is shown in FIG. 18, the magnetic element 18 is pivoted downward via the actuating element 65, with the result that it lies on the bottom 62 in the housing 61. As FIG. 18 shows clearly, it is situated exactly vertically above the element 8 which is situated closest to the web edge 75 and to which it magnetically couples directly in this position, although separated via the bottom 62. This element 8 is contained later in the actual cut-off strip; the strip is fixed on the hold-down section 17 via the element 8.

In the next step, as shown by way of the arrow 76, the gripping device 5, A is raised. The transfer table 30 is also simultaneously raised, as is shown by way of the arrow 77. The transfer table 30 is mounted pivotably with its end which faces the transport means 25, that is to say the end which is adjacent with respect to the blade table 14 can be raised. A type of ramp is therefore configured, which ramp raises the front end of the material web 3 at the same time as the gripping device 5, A.

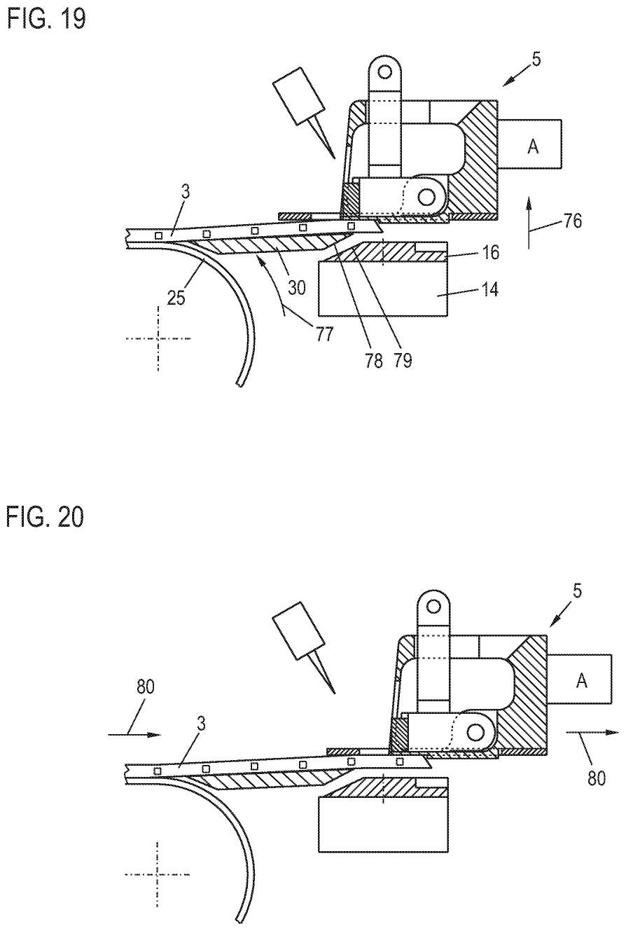

As FIG. 19 shows, that end of the transfer table 30 which is adjacent with respect to the blade table 14 is provided with a chamfer 78; a dimensionally compatible chamfer 79 is also provided on the liner 16 of the blade table 14; both lie adjacently in the lowered position (see FIG. 18).

In the next step, the actual advancing operation is performed. First of all, the advancing device 26 clamps (in this regard, see FIG. 7) the transport means 25. Directly after this, the horizontal advance of the slide 39 takes place via the corresponding slide drive or actuating cylinder, which leads to firstly the transport means 25 being driven by the displacement distance on account of the clamping action of the advancing device 26. Secondly, however, the gripping device 5 or A is simultaneously also moved in the transport direction by exactly the slide displacement distance. This leads to the material web 3 being displaced by exactly the required horizontal advancing length which corresponds precisely to the width of the strip 2 to be cut. This linear advancing movement is shown by way of the arrows 80 in FIG. 20.

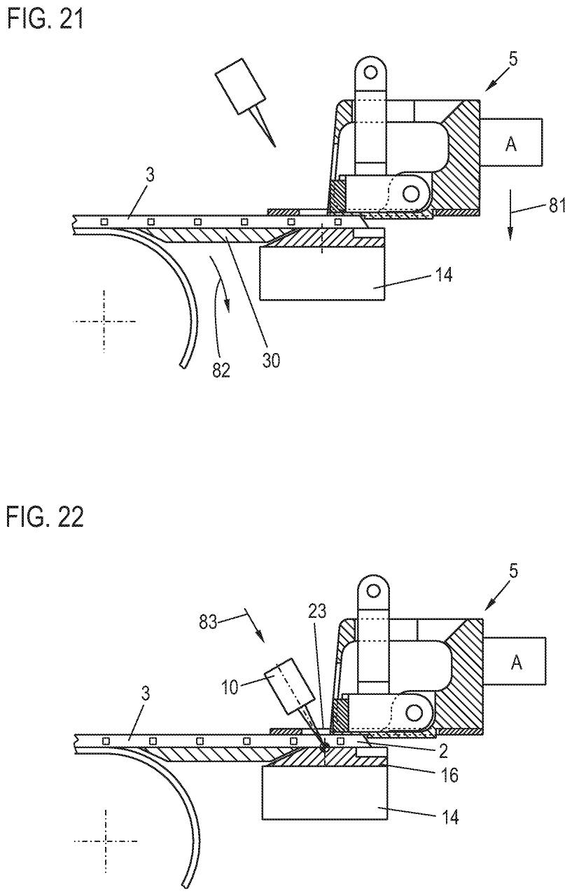

In the next step which is shown in FIG. 21, the gripping device 5, A is lowered again, with the result that the material web 3 is placed on the blade table 14 again. This movement is shown by way of the arrow 81. At the same time, the transfer table 30 is also pivoted downward again, as shown by way of the arrow 82. The material web 3 is then situated in the cutting position.

The cutting operation then takes place, see FIG. 22. The cutting blade 10 is moved through the recess 23 against the material web 3 until in contact with the liner 16 of the blade table 14, with the result that the strip 2 is completely cut off. Here, the material web 3 and the strip 2 which is then cut are fixed both in front of and behind the cutting line completely over the entire contact area, by way of which the hold-down section 17 lies on the material web 3, with the result that even an extremely small movement of the material web 3 is ruled out. The blade movement is shown by way of the arrow 83.

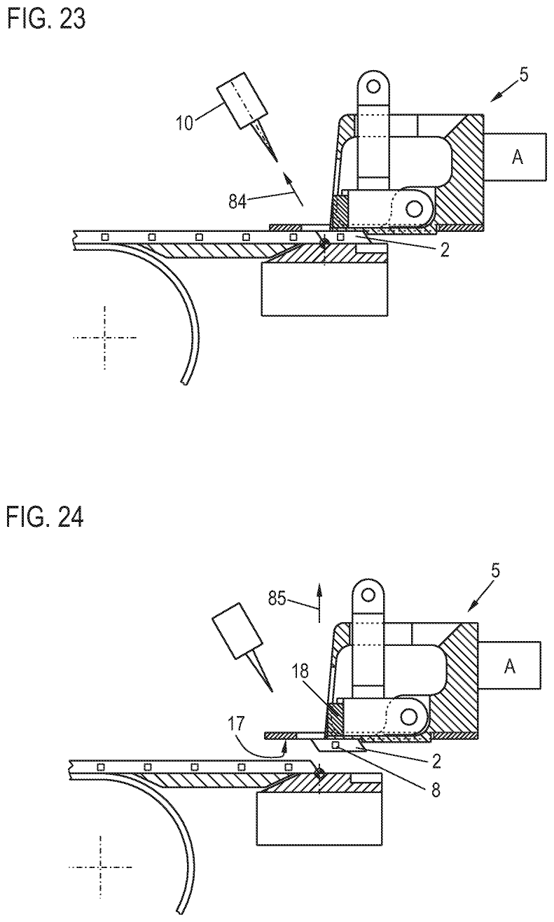

This fixing action is also maintained during the time, in which the cutting blade 10 is withdrawn again (see the arrow 84 in FIG. 23). The cutting operation is then concluded, and the strip 2 is cut off and separated.

In the following step which is shown in FIG. 24, the gripping device 5, A is raised again, as is shown by way of the arrow 85. As can be seen, the cut strip 2 is fixed on the underside of the gripping device 5, that is to say on the hold-down section 17, as a consequence of the magnetic interaction of the magnetic element 18 with the strip-side element 8, and can accordingly also be transported away.

The horizontal movement, performed with regard to the advancing operation of the material web 3, of the gripping device 5 is brought about by way of the horizontal displacement of the slide 39. The raising and lowering of the magnetically coupled web end within the context of the advancing operation, as described in respect of FIGS. 17 and 21, takes place by way of the vertical lifting and lowering of the holder 51 which is guided on the slide 39 in the linear guide 45. The vertical movement of the gripping device 5 for raising the cut strip 2, as described in respect of FIG. 24, takes place by way of the vertical actuating device 59, on which the gripping device 5 is seated directly.

FIGS. 25-35 then show the further work operations of the apparatus according to the invention, as they follow the step according to FIG. 24. The outline illustrations show the apparatus 1, since at least the principle of the receiving device 6 (without an optional winding apparatus here too) is also shown here.

Firstly, the gripping device A which has already been described in respect of FIGS. 15-24 and is situated in the position which is already known from FIG. 24 and in which the strip 2 is received and the gripping device A is raised is shown. Furthermore, the second gripping device B is shown which, arranged on the mounting plate 56 offset by 180° with respect to the gripping device A, is turned away from the blade table 14. The gripping device B has deposited the strip 2, which has already been transported via it to the receiving device 6, on this receiving device 6. It has already been moved somewhat out of the actual depositing region, to which end the receiving device 6 comprises a corresponding transport device, by means of which the carrier 7 including the strip 2 can be moved. Furthermore, the movement device 33 is also basically shown, which movement device 33 comprises the elements which are shown in FIGS. 7-10, apart from the two gripping devices A and B.

As FIG. 26 shows, the two gripping devices A, B are rotated about the rotational axis 60 (see FIG. 8) via the rotational device 54 in the next step, with the result that the gripping device B is situated above the material web 3 which is not yet situated in the cutting position, while the gripping device A is turned with the cut strip 2 toward the receiving device 6. At the same time (see the arrow 86), the slide 39 and, with it, all the elements of the movement device 31 which are arranged on it including the two gripping devices A, B are moved back counter to the transport direction. As a result of the connection of the open advancing device 26 to the slide 39, the advancing device 26 is also moved back again (see arrow 87).

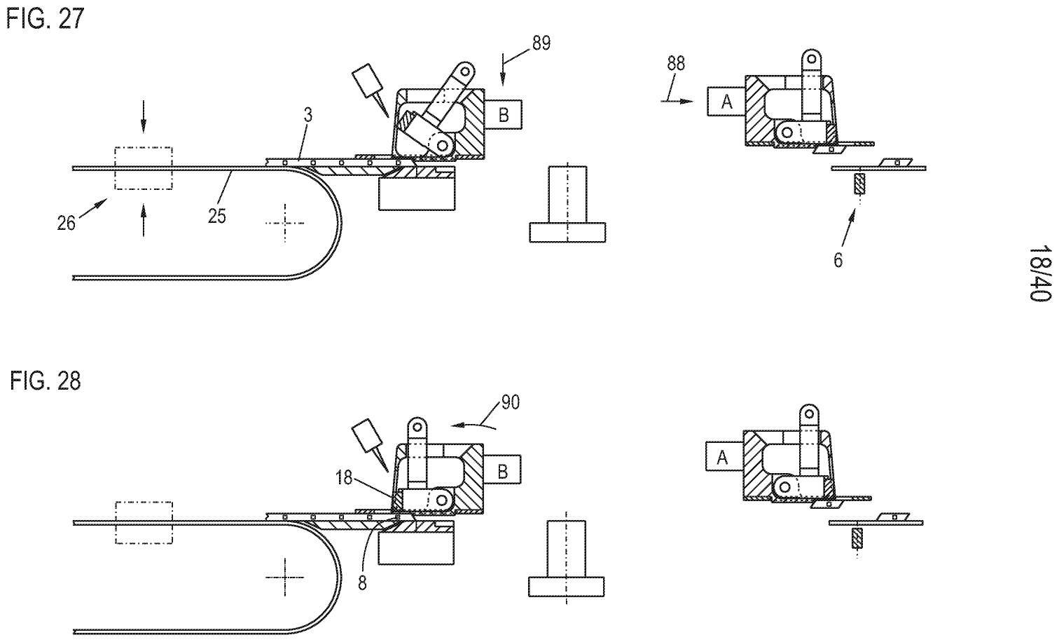

In the next step (see FIG. 27), the gripping device A firstly moves, as shown by way of the arrow 88, via the horizontal linear guide, formed via the guide elements 57, 58, in the direction of the receiving apparatus 6. It is not yet situated in the final depositing position, however.

Secondly, the gripping device B at the same time moves vertically downward (see arrow 89), which takes place via the vertical actuating device 59, with the result that the hold-down section 17 of the gripping device B is lowered onto the material web 3. The advancing device 26 also likewise at the same time closes again and clamps the transport means 25.

In the following step which is shown in FIG. 28, the magnetic element 18 of the gripping device B is moved downward again, as shown by way of the arrow 90, into the actual magnetic coupling position to the web-side element 8. That is to say, the front web end is accordingly then attached magnetically again on the gripping device B.

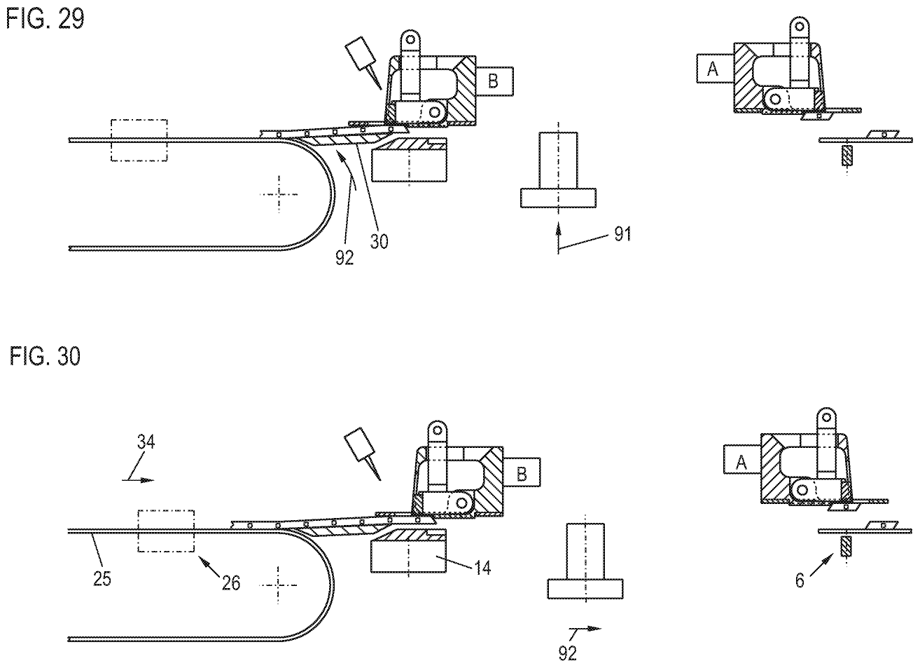

In the step which is shown in FIG. 29, the holder 51 and therefore the entire construction including the two gripping devices A, B are raised via the actuating element 47, as shown by way of the arrow 91 in FIG. 29. Here, the holder 51 is moved upward on the linear guide 45. At the same time, the transfer table 30 is also raised, as shown by way of the arrow 92. These two simultaneous movements lead to the front end, attached magnetically on the gripping device B, of the material web 3 being raised.

In the step which then follows according to FIG. 30, the slide 39 is once again displaced horizontally via its associated actuating element, as shown by way of the arrow 92. The actual synchronized web advancing operation takes place, by firstly the transport means 25 being moved in the transport direction 34 via the clamped advancing device 26, while at the same time the two gripping devices A and B are also moved by exactly this displacement distance which corresponds precisely to the width of the strip 2 to be cut. This movement leads firstly on the part of the gripping device A to the latter then being positioned exactly into the depositing position above the receiving device 6. Secondly, the gripping device B and, with it, the web end are moved exactly into the cutting position above the blade table 14.

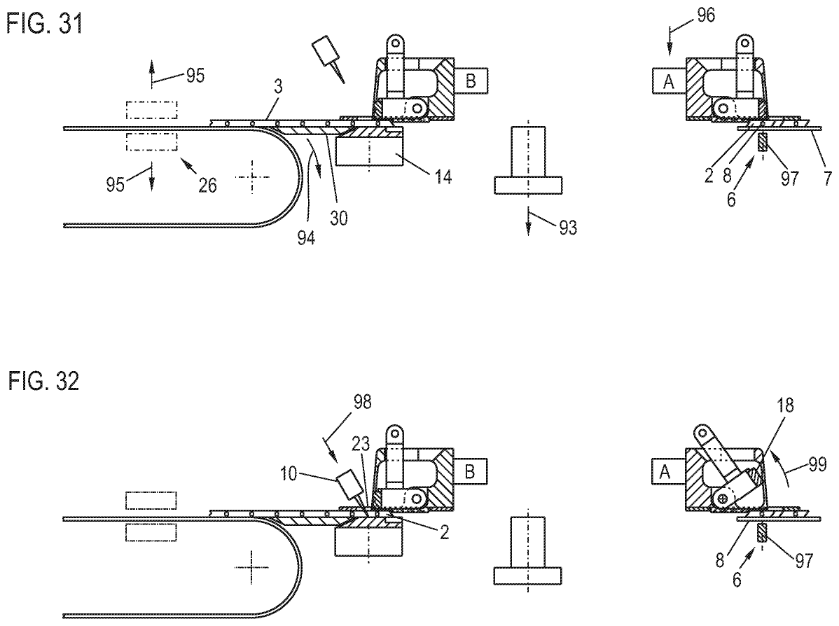

In the next step which is shown in FIG. 31, the holder 51 and, with it, all the attachment parts which are situated on it, that is to say also the two gripping devices A, B, is once again lowered, that is to say the actuating element 47 moves the holder 51 downward again on the linear guide 45. This is shown by way of the arrow 93 in FIG. 31. This stroke movement is small and is, for example, merely a few millimeters. It is sufficient, however, for the gripping device B to be lowered to such an extent that the material web 3 is deposited onto the blade table 14 and is as it were clamped thereon. At the same time, the transfer table 30 is of course also pivoted away, as shown by way of the arrow 94. As a consequence, the material web 3 is then situated in the cutting position for the next cutting operation.

Simultaneously with this, the clamping action of the advancing device 26 is likewise once again disengaged, and the transport means 25 is released again.

As described, the vertical actuating movement which can be brought about by the holder 51 is merely relatively small. The gripping device A is situated spaced apart by further from the receiving device 6, however, than the stroke of this stroke movement takes place according to arrow 93. In order for it then to be possible for the cut strip 2 to finally be deposited, the gripping device A (see the arrow 96) is moved via the vertical actuating device 59 finally into the depositing position, in which the strip 2 lies on the carrier 7. In this position, the strip 2 is situated exactly above a magnetic element 97 which is arranged below the carrier 5 and which magnetically fixes the element 8 in the strip 2 and therefore the strip 2 itself.

In the next step which is shown in FIG. 32, the actual cutting operation then takes place, and the blade 10 cuts through the recess 23 in the hold-down section 17, as shown by way of the arrow 98, with the result that the new strip 2 is separated.

At the same time as this, the magnetic element 18 is pivoted upward again on the part of the gripping device A, as shown by way of the arrow 99. The magnetic coupling of the magnetic element 18 to the strip-side element 8 is canceled, and the latter is then still coupled magnetically only to the magnetic element 97 of the receiving device 6.

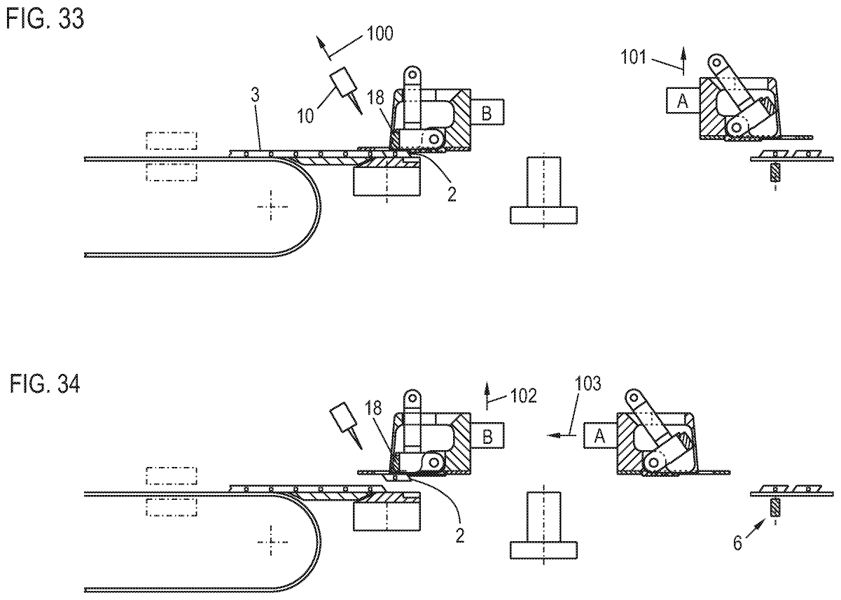

In the next step which is shown in FIG. 33, the cutting blade 10 then moves back again, as shown by way of the arrow 100, but the gripping device B still lies on the material web 3 and the strip 2 and still fixes both of them. The magnetic element 18 is still in the pivoted-away position.

The extending of the cutting blade 10 is also in turn accompanied by raising of the gripping device A, as shown by way of the arrow 101. This raising movement is brought about by way of the vertical actuating device 59.

In the step which then follows according to FIG. 33, the gripping device B also moves vertically upward again, as shown by way of the arrow 102, this vertical movement also being brought about via the vertical actuating device 59 of the gripping device B. As can be seen, the cut strip 2 is still coupled to the hold-down section 17 via the magnetic element 18.

At the same time, as shown by way of the arrow 103, the gripping device A moves along the horizontal linear guide, formed via the guide elements 57, 58, back into the starting position; it therefore moves away from the receiving apparatus 6. In the next step which then follows, the rotation in the horizontal plane is again brought about by the rotary drive 54, with the result that the “empty” gripping device A is rotated again above the material web 3 or the blade table 14, while the gripping device B with the previously cut strip 2 is rotated again to the receiving apparatus 6. This is shown by way of the arrow 104. At the same time, however, the slide 39 and, with it, of course all the attachment parts including the gripping devices A, B also moves counter to the transport direction again (see arrow 105), in order to subsequently initiate a new cycle. Together with the slide 39, the open advancing device 26 is also moved back again, as is shown by way of the arrow 106.

Furthermore, the synchronized transport of the carrier 7 including the strips 2 which are arranged on it then also takes place on the part of the receiving apparatus 6, in order to vacate the actual depositing position again, see the arrow 107.

A new cycle can then begin, as described above on the basis of FIG. 16 et seq.

The carrier 7 can be a sheet, as described. As an alternative, however, it can also be a blister or a box or the like.

Furthermore, the receiving apparatus 6 can also comprise a detection device, for example a camera system which detects the depositing position and continuously makes checks, in order for it to be possible if necessary for the individual actuating movements within the entire system to be adjusted. Any defective strip can also be detected and marked as a reject via this. As a result, defective cuts can be taken from the subsequent processing chain, and an uninterrupted working chain with exactly cut strips of the required quality can be ensured.

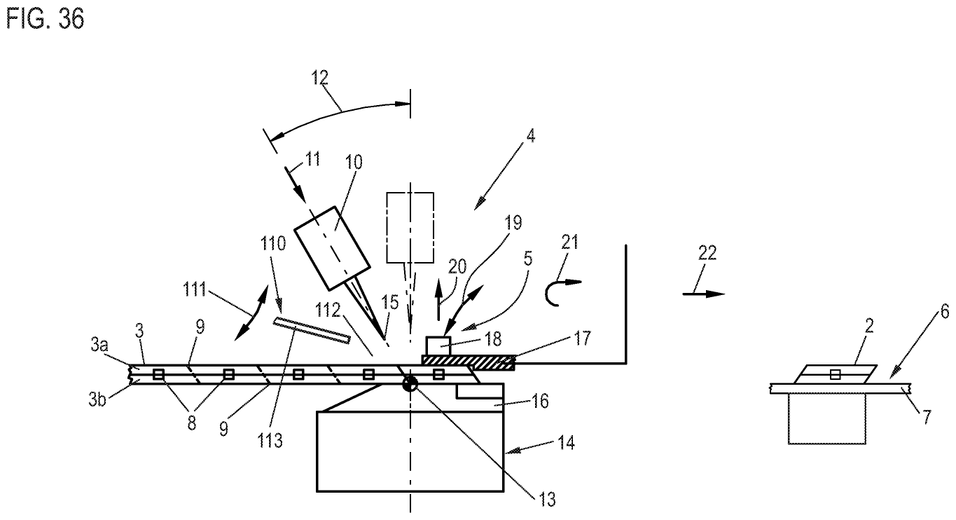

The following FIGS. 36-65 show outline illustrations of a cutting device according to the invention or apparatus in a second embodiment or of the second alternative according to the invention. The cutting device or the apparatus differs from the above-described cutting device or apparatus primarily in that a further separate hold-down element is provided in addition to the gripping device, and also a somewhat different process sequence. Reference is therefore made fundamentally to the above statements which, unless something different is described in the following text, also apply expressly to this second design alternative, as far as the essential elements of the cutting device are concerned. The same reference signs are also used for the same components, as far as possible.

FIG. 36 shows an outline illustration of an apparatus according to the invention in the second embodiment for producing and processing strips 2 of a material web 3, and, to this end, the apparatus 1 comprises a cutting device 4 which serves to cut the strips 2 from the material web 3. The cutting device 4 comprises at least one gripping device 5 which serves, inter alia, to receive and to transport a cut strip 2 to a downstream receiving device 6, where the separated strips 2 are deposited on a preferably sheet-like carrier 7. The receiving device 6 can also comprise a winding device (not shown in greater detail) for winding up the filled carrier to form a reel or spool, from which the individual strips are unwound again in a downstream processing device.

Here too, the material web 3 is an endless web consisting of an upper layer 3a and a lower layer 3b made from a rubber strip and magnetically couplable elements 8 which are received in between or embedded, preferably RFID chips, as an alternative metal strips or magnets. The cutting lines 9 which run obliquely here and along which the material web 3 is cut in order to form the strips 2 are shown using dashed lines.

The cutting device 4 serves to this end, which cutting device 4 comprises a cutting blade 10 which can be moved in a linear manner relative to the material web 3, as the arrow 11 shows. As indicated, the cutting blade 10 can be pivoted between the oblique position (shown using solid lines) according to FIG. 1 into a vertically upright position (shown using dashed lines), as indicated by way of the double arrow 12. Accordingly, the cutting angle can be varied via this. The pivoting takes place about a pivot axis 13 which preferably coincides with the cutting line on a blade table 14, on which the material web 3 lies during the cutting operation, and which cutting line is defined by way of the cutting edge 15 of the cutting blade 10 in the final cutting position. The blade table 14 comprises a corresponding liner 16 which is preferably made from a material which does not adhere to the material web 3 which is often adhesive.

Furthermore, as stated, a gripping device 5 is provided, comprising firstly a hold-down section 17 which fixes the material web on the blade table 14 during the cutting operation, and a magnetic element 18 which couples magnetically to an element 8, situated directly below it, of the material web 3, with the result that the cut strip 2 is attached magnetically via this to the gripping device 5 or the hold-down section 17, and can be transported away via the gripping device 5. Here, however, the hold-down section 17 is of considerably shorter dimensions than in the case of the first embodiment. The magnetic element 18, which can be a magnetic bar which contains a plurality of individual magnets, can be pivoted, as shown by way of the double arrow 19, and can be moved out of a non-working position into a coupling position, in which it is vertically above the element 8. The gripping device 5 itself can be moved vertically in every case, as shown by way of the arrow 20. The arrow 21 indicates that the raised gripping device 5 can be rotated in a horizontal plane about a vertical axis, while the arrow 22 indicates that a horizontal movement of the gripping device 5 can also take place. The individual degrees of freedom of movement will be described in detail in the following text.

Furthermore, a hold-down element 110 is provided which is arranged in front of the gripping section, as viewed in the conveying direction of the material web 3, and which can be moved between a raised position, as shown in FIG. 36, and a position which is lowered onto the material web, as shown by way of the double arrow 111. The material web can be held down via this in addition to the hold-down section 17. As can be seen, the hold-down element 110 is arranged spaced apart from the hold-down section 17, which results in a clearance 112 between the two, into which clearance 112 the cutting blade 10 can move. Here, the hold-down element 110 is configured by way of example as a pivotable flap 113, but can also be a bar which can be moved in a linear manner.

Since the strip 2 is very narrow and has, for example, only a width of between preferably 8 and 15 mm in the case of a possible length of, for example, from 70 to 80 mm, it is necessary for the material web 3 to be fixed with its leading edge correspondingly on the blade table 14 during the cutting operation, with the result that it is prevented that the material web 3 moves during the cutting operation and exact, continuous cutting is not possible. Since, on account of the small width of the strips 2 to be cut, the cutting operation necessarily has to take place very close to the free end of the material web 3, but at the same time fixing of the material web 3 over a relatively large area is also necessary, the fixing of the material web takes place in the case of this embodiment by means of the hold-down section 17 and the hold-down element 110 with the formation of the clearance 112 in the form of an elongate slot, through which clearance 112 the blade 10 cuts. The arrangement of the separate hold-down components makes it possible for the material web 3 to be fixed flatly and held down in front of and behind (as viewed in the transport direction) the actual cutting line or the cutting operation, with the result that any movement of the material web 3 is ruled out both during plunging down and pulling out of the cutting blade 10.

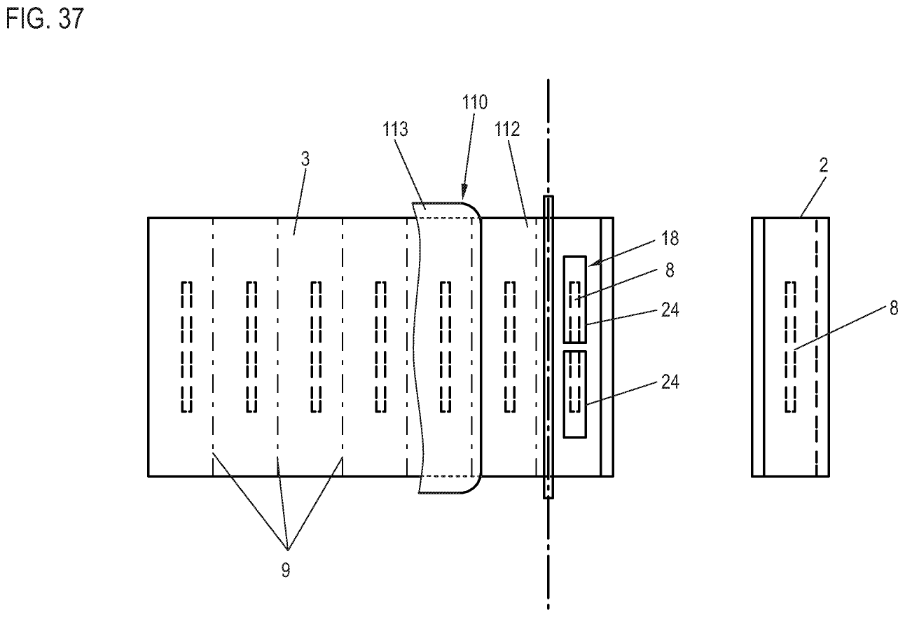

FIG. 37 shows a top view of the outline arrangement from FIG. 1. For reasons of improved illustration, the cutting blade 10 is not shown here, nor is the hold-down section 17.

In a similar manner to FIG. 2, the material web 3 is shown with the embedded elements 8 or RFID chips which are shown using dashed lines, the intended cutting lines 9 also being shown here. Furthermore, the clearance 112 is shown in the form of the elongate slot which is longer than the width of the material web 3, the cutting blade 10 which is shown in outline or the cutting edge 15 of course also being wider than the material web 3.

Furthermore, the magnetic element 18 is shown which is shown here in the form of two separate individual magnets 24 and which is arranged in the coupling position exactly above a web-side element 8, just like the cut and removed, rotated strip 2.

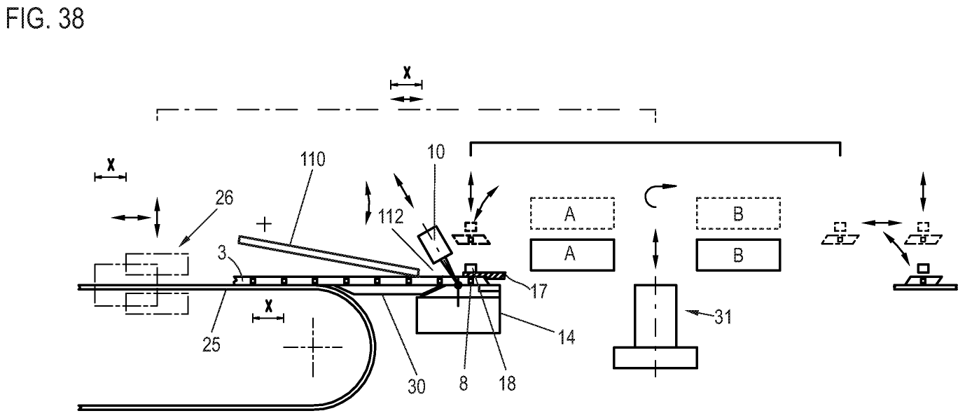

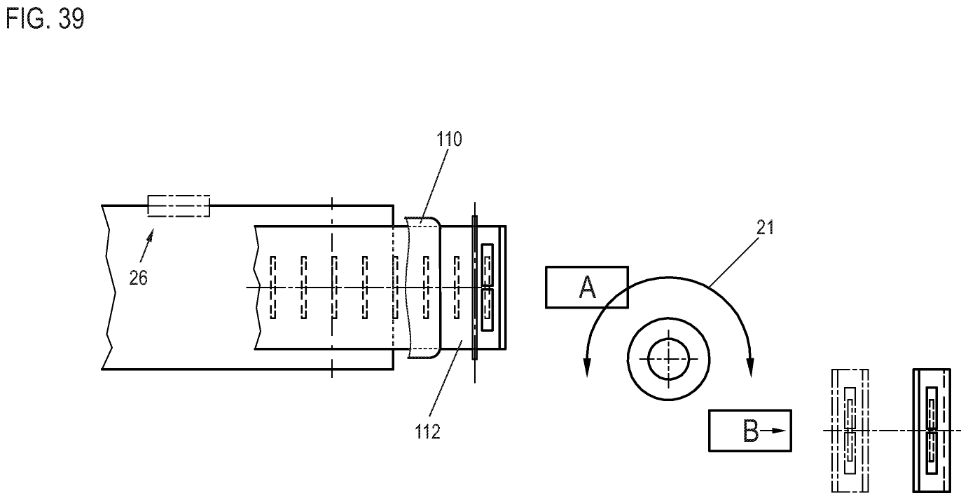

FIGS. 38 and 39 show a side view and a top view of a detail of the apparatus according to the invention in a more detailed form, two gripping devices 5 which, as also in the following case, are denoted by A and B being provided here.

The outline illustration shows the cutting device 1 with the transport means 25 in the form of a transport belt and the advancing device 26, for example a clamping unit. The material web 3 rests on the transport means 25. The transport belt ends adjacently with respect to, but spaced apart from, the blade table 14. A transfer table 30, over which the material web 3 is guided, is provided to bridge the gap between the transport means 25 and the blade table 14.

Furthermore, the cutting blade 10 is shown in outline, which is in the cutting position here and lies in the clearance 112. The hold-down section 17 and the flap-like hold-down element 110 are lowered onto the material web 3 and clamps the latter onto the blade table 14. The magnetic element 18 couples to the web-side element 8.

As described, two gripping devices 5 which are denoted here by A and B are provided here. They can be moved by way of a corresponding movement device 31 in several degrees of freedom, as shown in outline in FIGS. 38 and 39. Reference is made to the comments with respect to FIGS. 3 and 4 which likewise apply to the second embodiment.

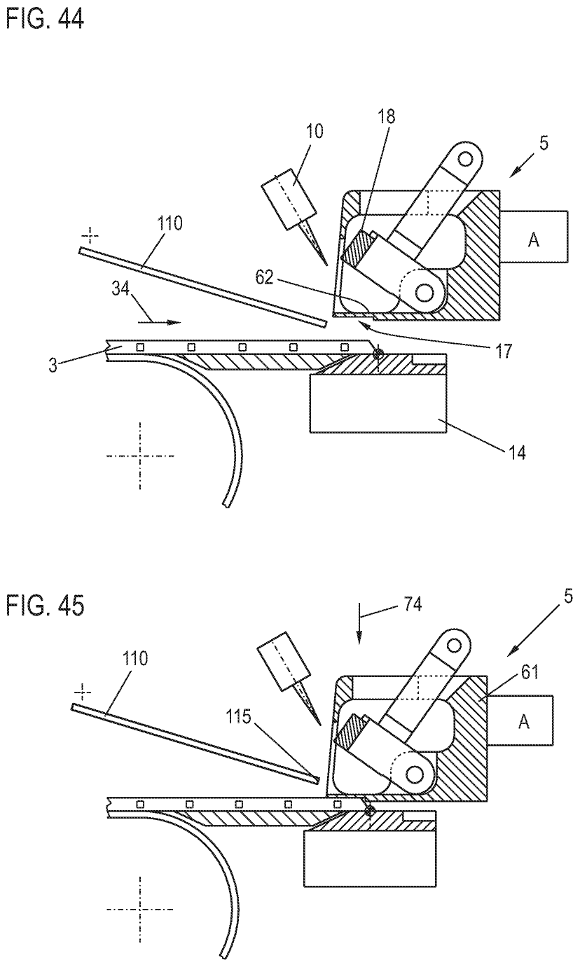

The exact work sequence will be described in the following text with reference to FIG. 44 et seq.

FIG. 40 shows a side view of the cutting device 4. The latter comprises a device frame 33, on which firstly the transport means 25 is arranged which conveys in the transport direction, as shown by way of the arrow 34. Furthermore, the cutting apparatus 35 comprising the cutting blade 10 and the blade table 14, and the movement device 31 and the two gripping devices 5 or A, B are arranged on the device frame 33. The hold-down element 110 which can be pivoted here is likewise arranged on the device frame or on a carrier which is arranged thereon.

With regard to further details, reference is made to the comments with respect to FIGS. 5 and 6 which likewise apply to the present second embodiment.

With regard to the movement device 31, its construction and its function, reference is made to the illustration in FIG. 7 and the detailed comments with respect to FIG. 7 which likewise also apply to the second embodiment. This is because the embodiment of the movement device 31 and the fundamental movement of the individual components of the second embodiment which are coupled to the movement device 31 and/or are moved via it correspond to those described in respect of the first embodiment. Merely the temporal sequence of the movement of the cutting blade 10 for raising after the cutting operation relative to the movement of the gripping device 5, A, B for raising including the strips is different; it will be described in the following text how the movement of the separate hold-down element 110 is also added here.

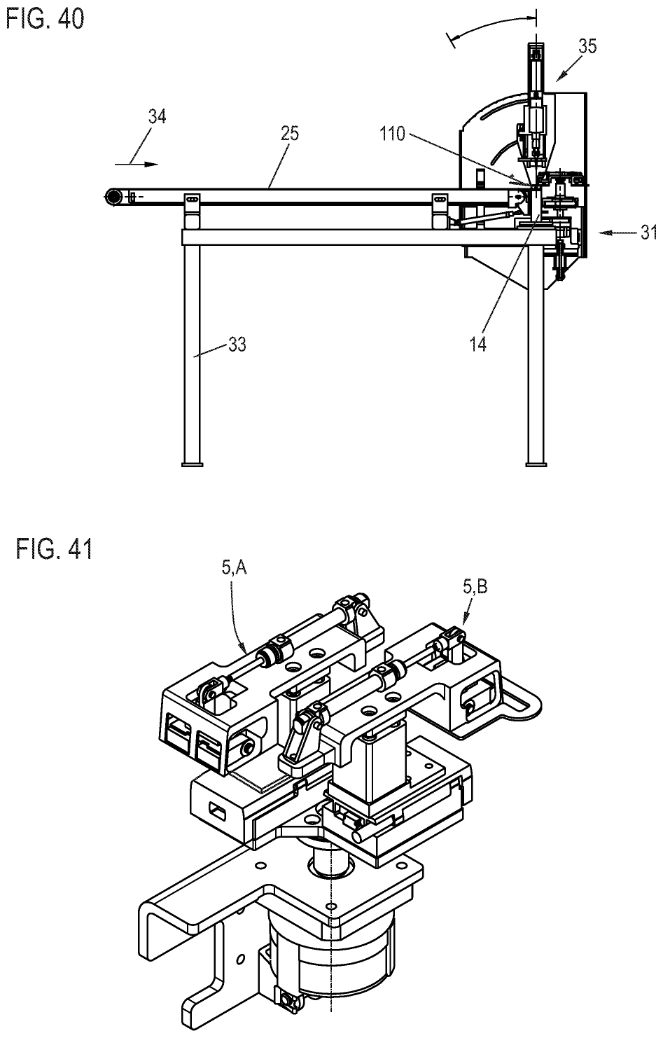

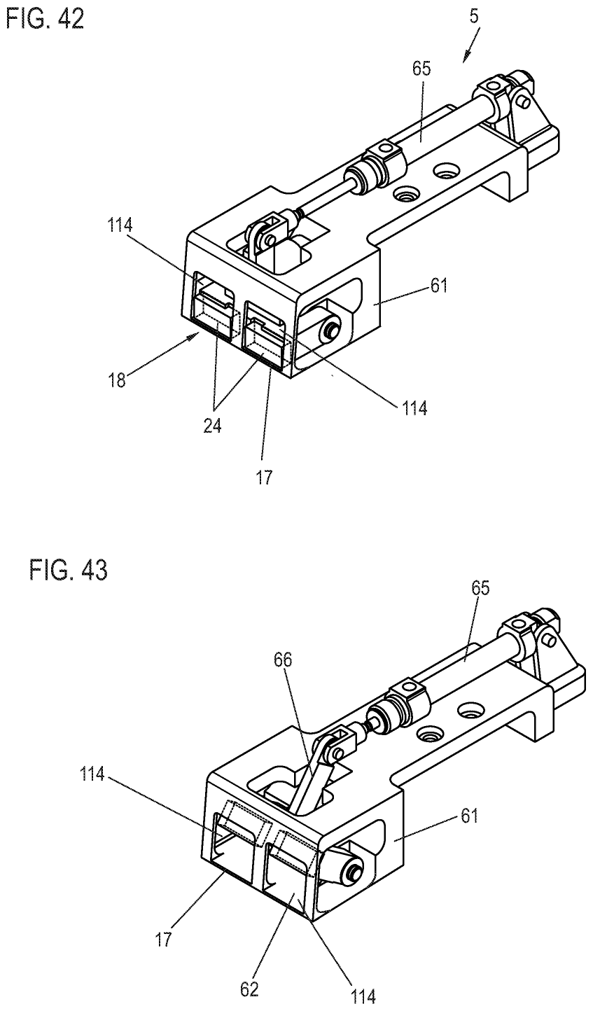

FIGS. 41-43 show the assemblies which are arranged on the slide such that they can be displaced vertically via the linear guide 45 (FIG. 41) and the gripping device 5 or A, B in detail (FIGS. 42 and 43). The construction and the function of the arrangement and the assemblies shown in FIG. 41 and the guides and movement correspond to precisely what is shown and described with respect to FIGS. 8-10 concerning the first embodiment, for which reason reference is made to the comments there which apply in the same way to the arrangement shown in FIG. 41. Merely the configuration of the respective gripping devices 5 or A, B is somewhat different here, as will be described in the following text. A gripping device 5, A, B is shown in detail in FIGS. 42 and 43.

FIGS. 42 and 43 show a gripping device 5 in detail, the configuration being identical for each gripping device A, B. The gripping device 5 comprises a housing 61 with a bottom 62, the bottom 62 or its underside forming the hold-down section 17. The gripping device 5 or the housing 61 is seated by way of the underside of the bottom, that is to say the hold-down section 17, on the material web 3, in order to fix it. As can be seen, the bottom 62 or the housing terminates virtually flush with the magnetic elements 18 which are lowered in order to grip the strip 2, the front edge of the bottom 62 delimiting the clearance 112, into which the cutting blade 10 plunges. A hold-down plate as in the case of the first embodiment is not provided here.

The magnetic element 18 is arranged here, with the two magnets 24, in the interior of the housing such that they can be pivoted about a pivot axis 64. They can as it were be pivoted into the two windows 114 which are open on the housing front side and provided directly above the front edge of the bottom 62, with the result that they extend as it were as far as the bottom edge and, in the lowered coupling position according to FIG. 42, couple magnetically to the web-side element 8, that is to say the RFID chip. An actuating element 65 in the form of a pneumatically, hydraulically or electrically operating actuating cylinder once again serves for pivoting purposes, which actuating cylinder is coupled to a corresponding pivoting lever 66, on which the magnetic element 18 is arranged. That is to say, via this actuating element 65, the magnetic element 18 can be placed as required onto the bottom 62 and can be brought into magnetic coupling with the web-side element 8, with the result that, after a cutting operation has taken place, the strip which runs below the bottom 62 which forms the hold-down section can be fixed magnetically on the underside of this hold-down section 17 and can be transported away by way of a movement of the gripping device 5.

With regard to the configuration and function of the cutting apparatus 35, reference is made to the comments in respect of FIGS. 13-15 relating to the first embodiment, which comments also apply in the same way to the cutting apparatus 35 of the second embodiment, concerning both the construction or the individual components and their function, and the corresponding movement capabilities of the components of the cutting apparatus 35, etc.

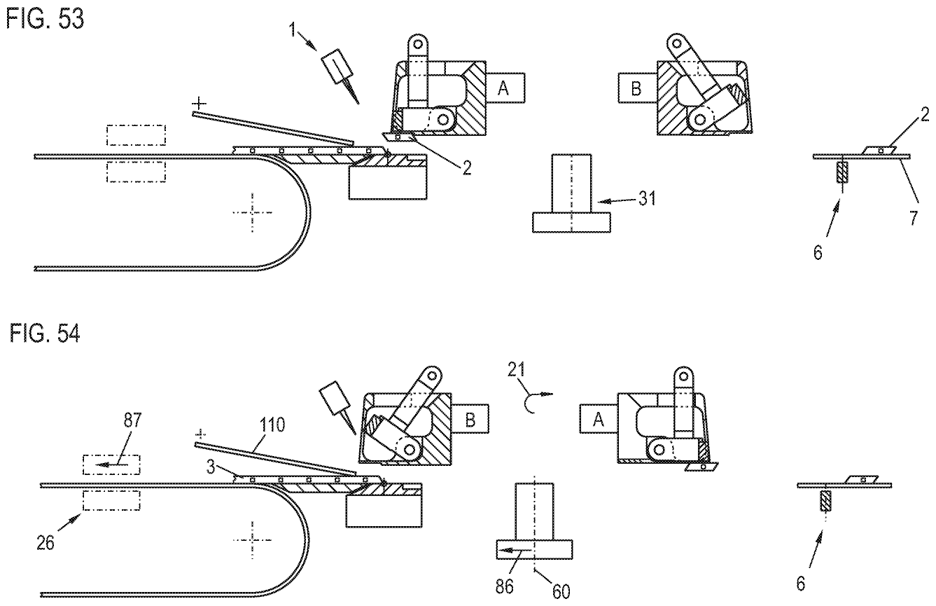

FIGS. 44-52 show corresponding outline illustrations of the method of operation of the cutting apparatus according to the invention in the second embodiment, firstly within the context of the web transport, and secondly within the context of the actual cutting operation, while the following FIGS. 53-63 illustrate the method of operation including the removal over an entire work cycle.

FIG. 44 shows the material web 3 in its position after a preceding cutting operation. As a consequence, it is not yet situated in the cutting position; it is first of all to be transported into this cutting position. The gripping device 5, which is labeled here as gripping device A since the second gripping device B is also illustrated in FIG. 53 et seq., is situated in a position above the blade table 14, the hold-down section 17, formed by the underside of the bottom 62, being positioned above the material web 3. The magnetic element 18 is pivoted upward, and the cutting blade 10 is remote from the gripping device 5, A. The flap-like hold-down element 110 is in the raised position, that is to say is likewise remote from the material web 3.

In the next step which is shown in FIG. 45, the gripping device 5, A is lowered, as shown by way of the arrow 74. The hold-down section 17 then lies on the material web 3. As can be seen, the front edge of the bottom 62 or the front side of the housing 61 is positioned closely adjacently with respect to the front edge 115 of the hold-down element 110.

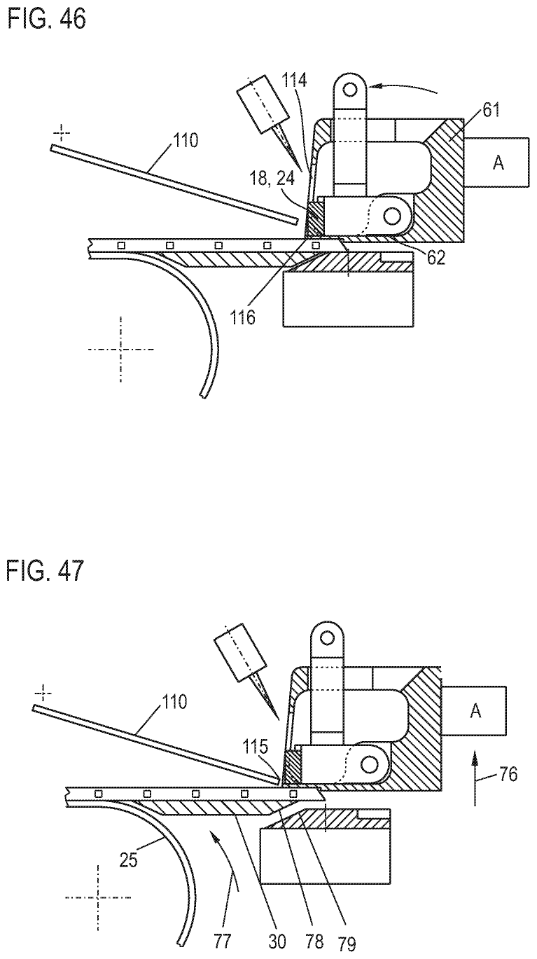

In the next step which is shown in FIG. 46, the magnetic element 18 is pivoted downward via the actuating element 65, with the result that it lies on the bottom 62 in the housing 61. As FIG. 46 clearly shows, it is situated exactly vertically above the element 8 which is situated closest to the web edge 75 and to which it directly couples magnetically in this position, although separated via the bottom 62. This element 8 is subsequently contained in the actual cut-off strip; via the element 8, the strip is fixed on the hold-down section 17. As can be seen, the magnetic element 18 lies, in this position, directly on the front side of the housing 61, and ends almost vertically above the front edge 116 of the bottom 62; the magnets 24 are situated as it were in the windows 114. The hold-down element 110 is still raised.

In the next step according to FIG. 47, the gripping device 5, A is raised, as shown by way of the arrow 76. The transfer table 30 is also simultaneously raised, as shown by way of the arrow 77. The transfer table 30 is mounted pivotably with its end which faces the transport means 25, that is to say the end which is adjacent with respect to the blade table 14 can be raised. A type of ramp is therefore formed which raises the front end of the material web 3 at the same time as the gripping device 5, A. Although the material web 3 is raised somewhat, it is still spaced apart somewhat from the edge 115 of the hold-down element 110.

As FIG. 47 shows, that end of the transfer table 30 which is adjacent with respect to the blade table 14 is provided with a chamfer 78; a dimensionally compatible chamfer 79 is also provided on the liner 16 of the blade table 14; both lie adjacently in the lowered position (see FIG. 18).

In the next step (see FIG. 48), the actual advancing operation is performed. First of all, the advancing device 26 clamps (in this regard, see FIG. 7) the transport means 25. Immediately subsequently, the horizontal advancing of the slide 39 takes place via the corresponding slide drive or actuating cylinder, which leads firstly to the transport means 25 being driven by the displacement distance on account of the clamping action of the advancing device 26. Secondly, however, the gripping device 5 or A is also simultaneously moved in the transport direction by exactly the slide displacement distance. This leads to the material web 3 being displaced by exactly the required horizontal advancing length which corresponds precisely to the width of the strip 2 to be cut. This linear advancing movement is shown by way of the arrows 80 in FIG. 20. As can be seen, the gripping device 5 moves away from the pivotable, but positionally fixed hold-down element 110 in the web transport direction; the spacing increases.

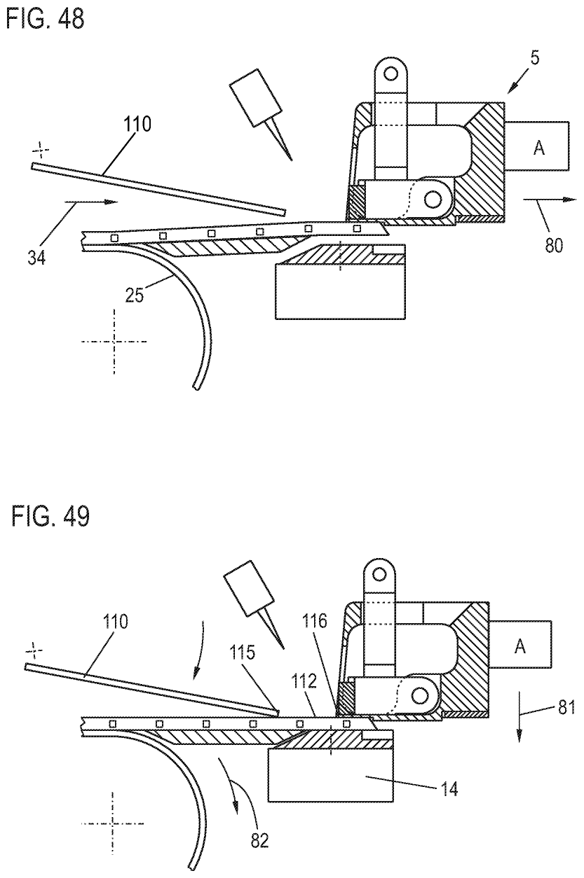

In the next step which is shown in FIG. 49, the gripping device 5, A is lowered again, with the result that the material web 3 is deposited on the blade table 14 again. This movement is illustrated by way of the arrow 81. At the same time, the transfer table 30 is also again pivoted downward, as shown by way of the arrow 82. The material web 3 is then situated in the cutting position. At the same time, the hold-down element 110 is also lowered, with the result that it or its edge 115 lies as it were in a linear manner on the material web 3 and fixes it. The material web is therefore held down or fixed twice, once via the hold-down section 17 of the gripping device 5, and secondly via the hold-down element 110. Here, the slot-shaped clearance 112 which is only a few centimeters wide is configured between the hold-down element 110 or its edge 115 and the hold-down section 17 or its edge 114, or is delimited via the edges 115, 116.

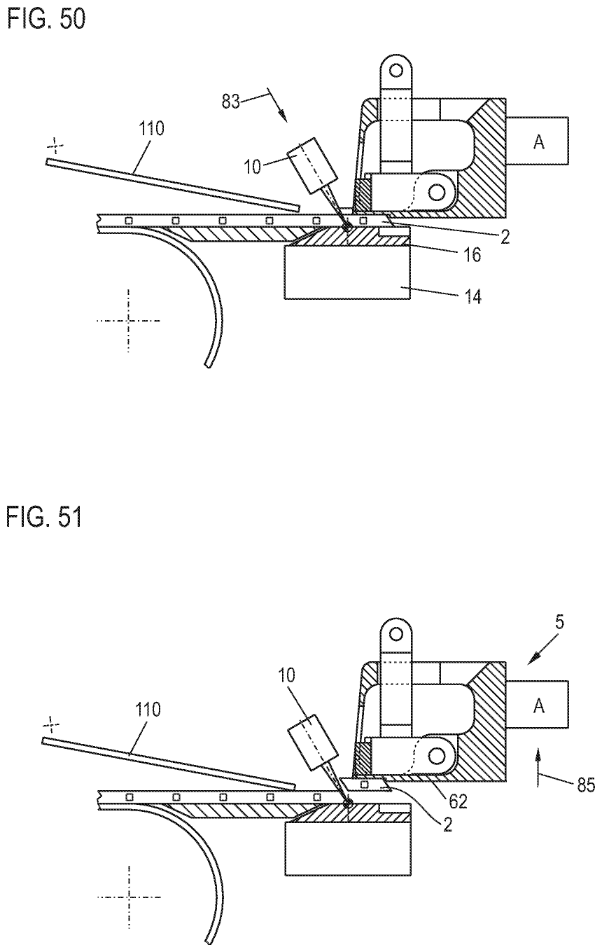

The cutting operation then takes place (see FIG. 50). The cutting blade 10 is moved through the clearance 112 against the material web 3 until it comes into contact with the liner 16 of the blade table 14, with the result that the strip 2 is completely cut off. Here, the material web 3 and the strip 2 which is then cut are fixed completely over the entire web width both in front of and behind the cutting line, with the result that even an extremely small movement of the material web 3 is ruled out. The blade movement is shown by way of the arrow 83.

After the cutting operation, that is to say when the cutting blade has cut through as far as the liner 16, it first of all remains in this position. The gripping device 5 moves up, however (see FIG. 51 and the arrow 85), with the result that the strip 2 which, as described, is coupled magnetically to the underside of the bottom 62, is also raised. Here, the cutting blade forms a dividing plane between the strip 2 and the remaining material web 3, and brings it about that both no longer come into contact and can adhere to one another again before lifting of the gripping device. Secondly, the fixing of the material web via the hold-down element 110 is maintained; it is not moved, just like the cutting blade 10.

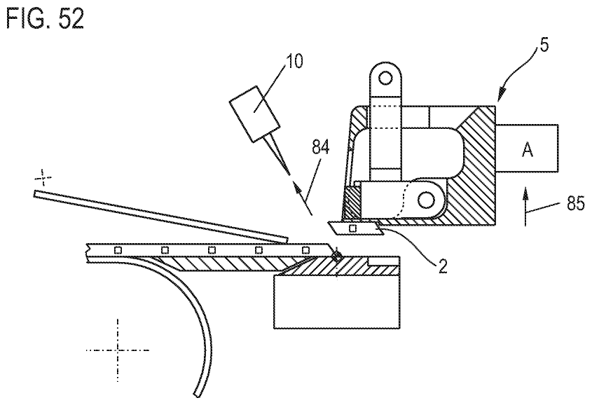

In the following step which is shown in FIG. 52, the cutting blade 10 is raised again (see the arrow 84), just as the gripping device 5 is also raised further, as shown by way of the arrow 85. The raising of the cutting blade 10 already starts when the gripping device 5 is raised to such an extent that the strip 2 is positioned at a higher point than the material web 3 and both cannot come into contact again in any case during raising of the cutting blade. During the raising of the cutting blade 10, the hold-down element 110 still remains in the lowered position on the material web; the latter is therefore also fixed on this side during the raising movement of the cutting blade 10. This ensures that, should it adhere slightly to the cutting blade 10, the material web edge is not also raised during the raising of the cutting blade 10.

The horizontal movement (performed with regard to the advancing operation of the material web 3) of the gripping device 5 is brought about by way of the horizontal advance of the slide 39. The raising and lowering of the magnetically coupled web end within the context of the advancing operation, as described with respect to FIGS. 17 and 21, take place by way of the vertical raising and lowering of the holder 51 which is guided on the slide 39 in the linear guide 45. The vertical movement of the gripping device 5 for raising the cut strip 2 (as described with respect to FIG. 24) takes place by way of the vertical actuating device 59, on which the gripping device 5 is seated directly. The movement of the hold-down element 110 takes place via a suitable actuating element which is coupled to the flap 113 or the hold-down element 110 which can be moved about a pivot axis, which will be described in greater detail in the following text.

FIGS. 53-63 then show the further work operations of the apparatus according to the invention, as they follow the step according to FIG. 52. The outline illustrations show the apparatus 1, since the receiving device 6 (also without an optional winding apparatus here) is also shown here, at least in principle.

Firstly, the gripping device A which has already been described with respect to FIGS. 44-52 is shown, which gripping device A is situated in the position which is already known from FIG. 52 and in which the strip 2 is received and the gripping device A is raised. Furthermore, the second gripping device B is shown which is turned away from the blade table 14, since it is arranged on the mounting plate 56 offset by 180° with respect to the gripping device A. The gripping device B has deposited the strip 2 which has already been transported via it to the receiving device 6 onto the latter. It has already been moved somewhat out of the actual depositing region, to which end the receiving device 6 comprises a corresponding transport device, by means of which the carrier 7 including the strip 2 can be moved. Furthermore, the movement device 33 is also basically shown, which movement device 33 comprises the elements shown in FIGS. 7-10 and described in detail there, apart from the two gripping devices A and B.

As FIG. 54 shows, in the next step the two gripping devices A, B are rotated about the rotational axis 60 (see FIG. 8) via the rotational device 54, with the result that the gripping device B is situated above the material web 3 which is not yet situated in the cutting position, while the gripping device A with the cut strip 2 is turned toward the receiving device 6. At the same time (see the arrow 86), the slide 39 and, with it, all of the elements arranged on it of the movement device 31 including the two gripping devices A, B are moved back counter to the transport direction. As a consequence of the connection of the open advancing device 26 to the slide 39, the advancing device 26 is also moved back again (see arrow 87). The hold-down element 110 is still situated in the lowered position which fixes the material web 3.

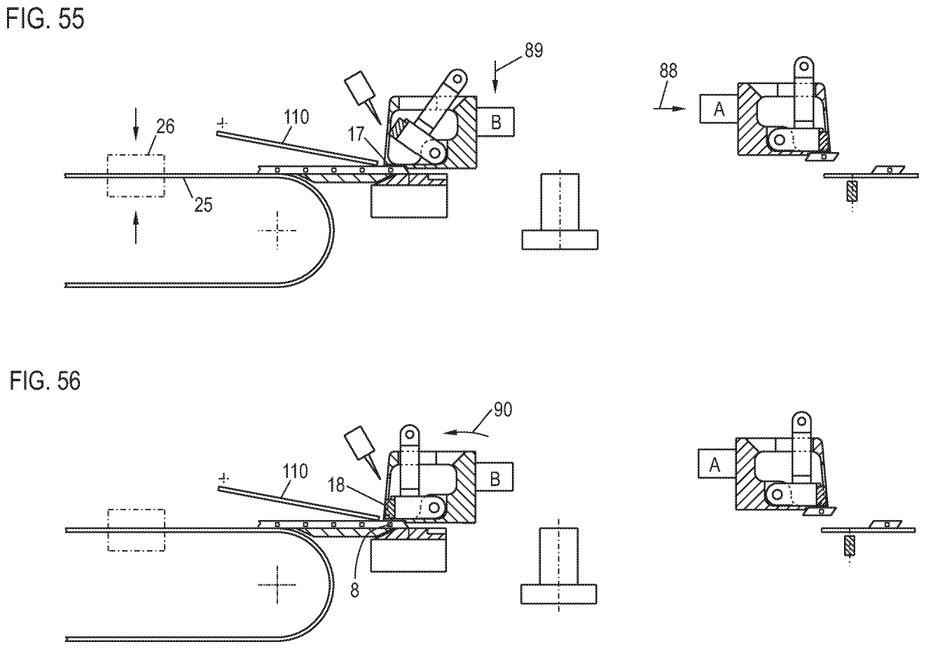

In the next step (see FIG. 55), firstly the gripping device A moves, as shown by way of the arrow 88, over the horizontal linear guide, formed via the guide elements 57, 58, in the direction of the receiving device 6. It is not yet situated in the final depositing position, however.

Secondly, the gripping device B at the same time moves vertically downward (see arrow 89), which takes place via the vertical actuating device 59, with the result that the hold-down section 17 of the gripping device B is lowered onto the material web 3. Likewise at the same time, the advancing device 26 also closes again and clamps the transport means 25. The hold-down element 110 or the flap 113 is still situated in the lowered position on the material web 3.

In the following step which is shown in FIG. 56, the magnetic element 18 of the gripping device B is moved downward again (as shown by way of the arrow 90) into the actual magnetic coupling position with the web-side element 8. That is to say, the front web end is then accordingly attached magnetically again to the gripping device B, and is additionally fixed via the hold-down element 110, that is to say the flap 113.

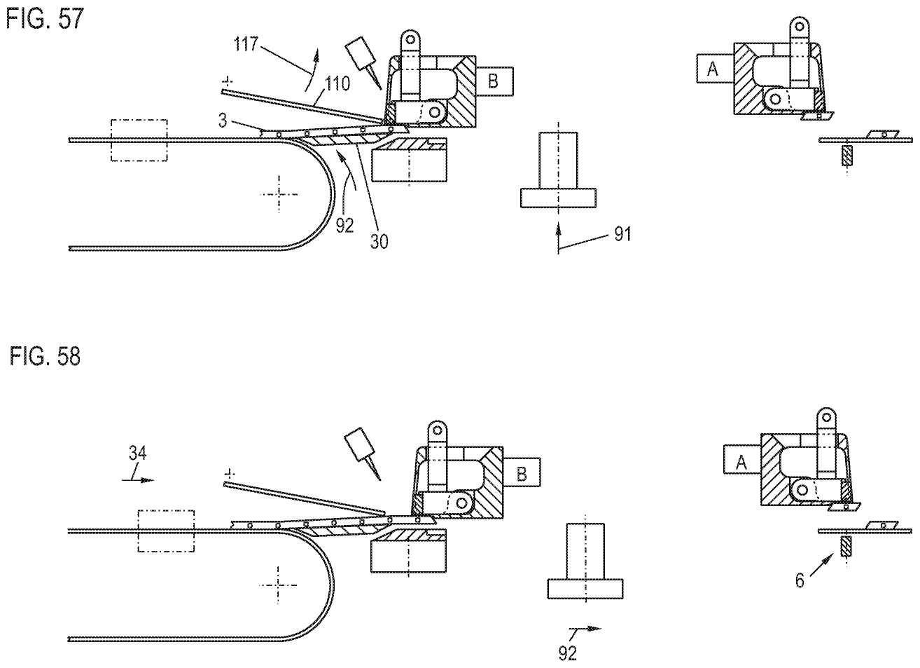

In the step which is shown in FIG. 57, the holder 51 and therefore the entire construction including the two gripping devices A, B are raised via the actuating element 47, as shown by way of the arrow 91 in FIG. 29. Here, the holder 51 is moved upward on the linear guide 45. At the same time, the transfer table 30 is also raised, as shown by way of the arrow 92. These two simultaneous movements lead to the front end, attached magnetically to the gripping device B, of the material web 3 being raised. Likewise at the same time, and possibly also slightly earlier, the hold-down element 110 is also raised via its actuating element (see arrow 117), that is to say the clamping action of the material web 3 is released on this side.

In the step which then follows according to FIG. 58, the slide 39 is once again displaced horizontally via its associated actuating element, as shown by way of the arrow 92. The actual synchronized web advancing operation takes place, in which firstly the transport means 25 is moved in the transport direction 34 via the clamped advancing device 26, while at the same time the two gripping devices A and B are also moved by exactly this displacement distance which corresponds precisely to the width of the strip 2 to be cut. This movement leads firstly on the part of the gripping device A to it then being positioned exactly into the depositing position above the receiving device 6. Secondly, the gripping device B and, with it, the web end are moved exactly into the cutting position above the blade table 14.

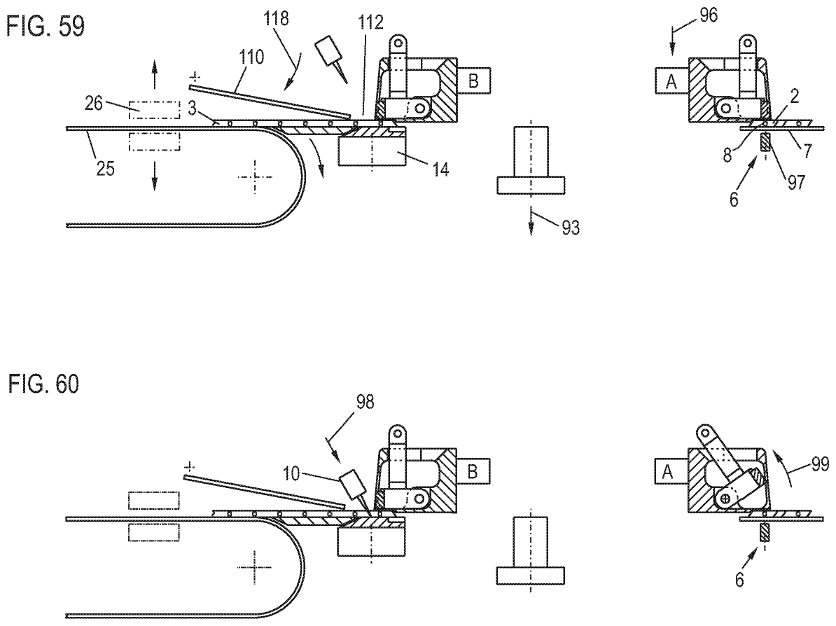

In the next step which is shown in FIG. 59, the holder 51 and, with it, all the attachment parts situated on it, that is to say also the two gripping devices A, B, are once again lowered, that is to say the actuating element 47 moves the holder 51 downward again on the linear guide 45. This is shown by way of the arrow 93 in FIG. 31. This stroke movement is small and is, for example, only a few millimeters. It is sufficient, however, for the gripping device B to be lowered to such an extent that the material web 3 is deposited onto the blade table 14 and is as it were clamped thereon. At the same time, the transfer table 30 is of course also pivoted away (as shown by way of the arrow 94). As a consequence, the material web 3 is then situated in the cutting position for the next cutting operation. Likewise simultaneously, or slightly afterward, the hold-down element 110 is also lowered again onto the material web 3, as shown by way of the arrow 118. In this way, the material web 3 is at two positions again, namely via the gripping device 5 including the hold-down section 17 and the hold-down element 110. Both are spaced apart from one another again with the formation of the clearance 112.

Likewise simultaneously to this, the clamping action of the advancing device 26 is again disengaged, and the transport means 25 is released again.

As described, the vertical actuating movement which can be brought about via the holder 51 is only relatively small. The gripping device A is situated, however, spaced apart further from the receiving device 6 than the distance covered by the stroke of this stroke movement according to arrow 93. In order for it then to be possible for the cut strip 2 to be deposited finally, the gripping device A is moved via the vertical actuating device 59 (see the arrow 96) finally into the depositing position, in which the strip 2 lies on the carrier 7. In this position, the strip 2 is situated exactly above a magnetic element 97 which is arranged below the carrier 7 and which magnetically fixes the element 8 in the strip 2 and therefore the strip 2 itself.

In the next step which is shown in FIG. 60, the actual cutting operation then takes place, and the blade 10 cuts through the clearance 112 (as shown by way of the arrow 98), with the result that the new strip 2 is separated.

At the same time as this, the magnetic element 18 is pivoted upward again on the part of the gripping device A, as shown by way of the arrow 99. The magnetic coupling of the magnetic element 18 to the strip-side element 8 is canceled, and it is then still coupled magnetically only to the magnetic element 97 of the receiving device 6.

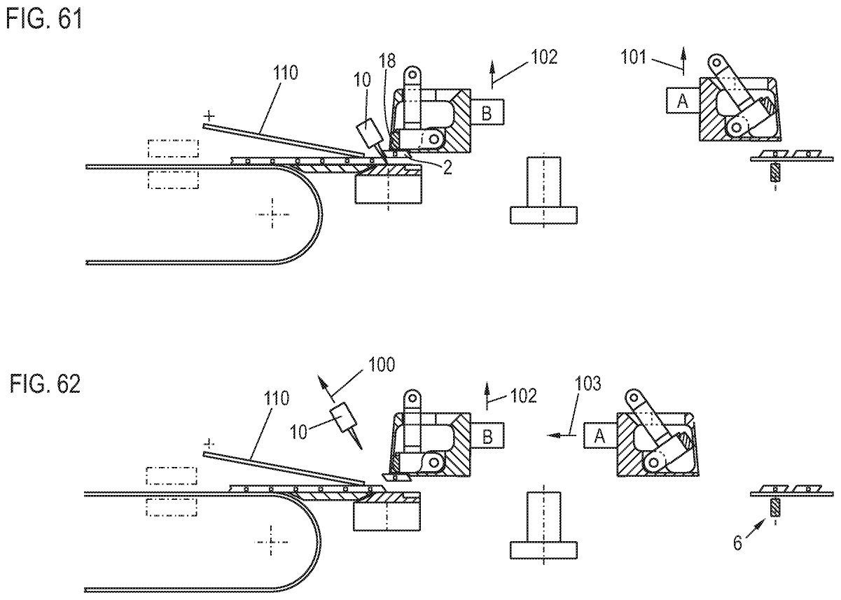

In the next step which is shown in FIG. 61, the gripping device B then moves upward again, as shown by way of the arrow 102. The hold-down element 110 still remains lowered on the material web 3, just as the cutting blade 10 also still remains in the cutting position, with the result that the strip 2 can be separated without problems. As can be seen, the cut strip 2 is still coupled to the hold-down section 17 via the magnetic element 18. At the same time, the gripping device A also moves upward (see arrow 101).

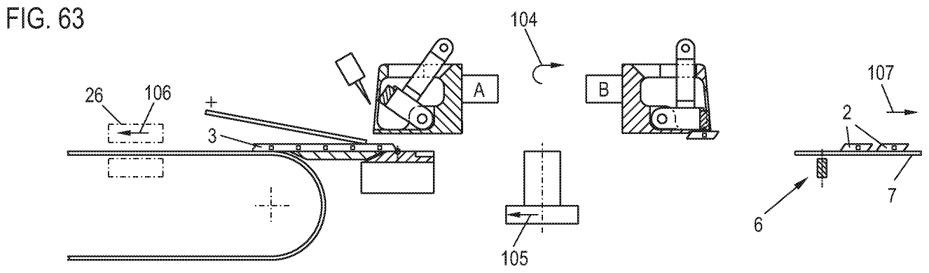

As FIG. 62 shows, firstly the gripping device B moves further upward in the next step, but at the same time the cutting blade 10 is also moved upward again since the strip 2 is separated. The hold-down element 110 remains lowered. At the same time, as shown by way of the arrow 103, the gripping device A moves along the horizontal linear guide, formed via the guide elements 57, 58, back into the starting position, that is to say it moves away from the receiving device 6. In the next step which then follows (see FIG. 63), the rotation in the horizontal plane is brought about again via the rotary drive 54, with the result that the “empty” gripping device A is rotated again over the material web 3 or the blade table 14, while the gripping device B with the previously cut strip 2 is rotated again toward the receiving apparatus 6. This is shown by way of the arrow 104. At the same time, however, the slide 39 (see arrow 105) and, with it, of course all the attachment parts including the gripping devices A, B is also moved again counter to the transport direction, in order to subsequently initiate a new cycle. Together with the slide 39, the open advancing device 26 is also moved back again, as shown by way of the arrow 106.

Furthermore, the synchronized transport of the carrier 7 including the strips 2 which are arranged on it then also takes place on the part of the receiving apparatus 6, in order to vacate the actual depositing position again (see the arrow 107).

A new cycle can then begin, as described in the preceding text on the basis of FIG. 44 et seq.

Here too, the receiving apparatus 6 can comprise a detection device, for example a camera system which detects the depositing position and continuously makes checks, in order for it to be possible for the individual actuating movements within the entire system to possibly be adjusted. Any defective strip can also be detected and marked as a reject via this. As a result, defective cuts can be taken from the subsequent processing chain, and an uninterrupted working chain with exactly cut strips of the required quality can be ensured.

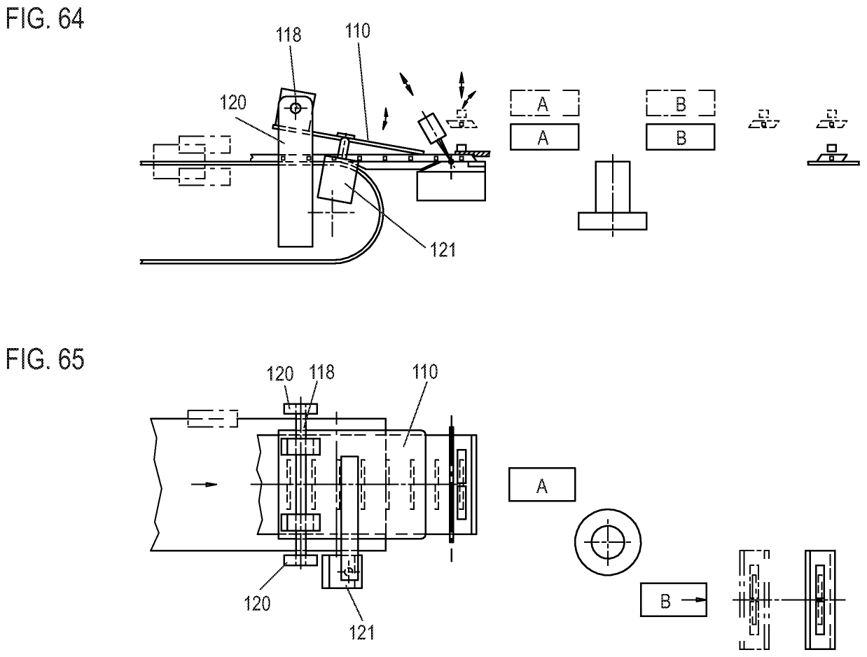

FIGS. 64 and 65 finally show a side view and a top view of the apparatus in the second embodiment, where the movement arrangement for moving the hold-down element 110 is also shown. The hold-down element 110 is mounted such that it can be rotated about a rotational axis 118 on carriers 120, two cheeks arranged on both sides here and arranged on the machine frame. Furthermore, the hold-down element 110 is coupled to an actuating element 121, for example a pneumatic or hydraulic cylinder, which brings about the movement of the hold-down element 110 (that is to say, the flap 113 here) in both directions and can be actuated correspondingly.

As an alternative to the flap 113, the hold-down element 110 can also be configured as a linearly movable bar which, via a linear guide, can be placed, for example, vertically from above onto the material web and can be raised, and is likewise controlled via an actuating element. The bar also acts with a narrow edge on the material web 3, with the result that there is only linear contact which brings about little adhesion.

The cutting blade is either an ultrasonic blade or a heated cutting blade. The two blade types can be used in both embodiments or alternatives of the cutting device.

While specific embodiments of the invention have been shown and described in detail to illustrate the inventive principles, it will be understood that the invention may be embodied otherwise without departing from such principles.

We claim:

1. A cutting device for cutting narrow strips from a material web, in particular a rubberized material web, in or on which magnetically couplable elements are embedded or arranged at defined spacings behind one another in the web longitudinal direction, comprising a blade table which is arranged on a device frame, and on which the material web to be cut can be positioned, a cutting apparatus comprising a cutting blade which can be moved out of a starting position into a cutting position relative to the blade table, and a gripping device which receives and transports a cut strip and can be moved relative to the blade table,
either the gripping device comprising a hold-down section which can be placed for cutting purposes onto the material web which is positioned on the blade table and fixes the material web during the cutting on the blade table, and a magnetic element which interacts magnetically with the magnetically couplable element of the cut strip for fixing the strip on the gripping device for transport into a dispensing position, and the hold-down section comprising a recess, through which the cutting blade can be moved to the blade table into the cutting position,
or the gripping device comprising a hold-down section which can be placed for cutting purposes onto the material web which is positioned on the blade table and fixes the material web during the cutting on the blade table, and a magnetic element which interacts magnetically with the magnetically couplable element of the cut strip for fixing the strip on the gripping device for transport into a dispensing position, and at least one further hold-down element being provided which can be placed onto the material web for cutting purposes spaced apart from the hold-down section with the configuration of a clearance, it being possible for the cutting blade to be moved through the clearance to the blade table into the cutting position.

2. The cutting device according to claim 1, wherein the recess or the clearance is configured as an elongate slot.

3. The cutting device according to claim 1, wherein the gripping device comprises a housing with a bottom and a hold-down plate which is arranged thereon, or a carrier and possibly a hold-down plate which is arranged thereon, the hold-down plate and at least one section of the bottom or the carrier forming the hold-down section, or only a section of the carrier forming the hold-down section, or in that the lower side of the housing or the bottom or the carrier itself forms the hold-down section.

4. The cutting device according to claim 3, wherein the recess, in particular the slot, is provided between the hold-down plate and the housing or the carrier, or in that the clearance is configured between the hold-down element and the housing or the bottom or the carrier.

5. The cutting device according to claim 3, wherein the magnetic element interacts with the magnetically couplable element through the bottom or the carrier.

6. The cutting device according to claim 3, wherein a projection which forms a run-on edge for the material web is provided on that side of the bottom or of the carrier which faces the blade table.

7. The cutting device according to claim 1, wherein the magnetic element is arranged on or in the housing or on the carrier such that it can be moved between a raised and a lowered position, in which it interacts magnetically with the element.

8. The cutting device according to claim 6, wherein the magnetic element is mounted pivotably on the housing or carrier.

9. The cutting device according to claim 1, wherein the hold-down element can be moved in a linear or pivotable manner relative to the material web by means of a movement device.

10. The cutting device according to claim 9, wherein the hold-down element is a bar which can be moved in a linear or pivotable manner or a pivotable flap.

11. The cutting device according to claim 10, wherein the bar or the flap can be placed with an edge onto the material web.

12. The cutting device according to claim 1, wherein the cutting blade is an ultrasonic cutting blade or a heatable cutting blade.

13. The cutting device according to claim 1, wherein the cutting blade is arranged on a blade carrier which is arranged on a holder such that it can be moved in a linear manner.

14. The cutting device according to claim 13, wherein the holder can be pivoted relative to the device frame about a pivot axis which runs horizontally, perpendicularly with respect to the longitudinal direction of the material web.

15. The cutting device according to claim 14, wherein the pivot axis coincides with a cutting line which lies in the plane of the blade table and is defined via a cutting edge of the cutting blade in the cutting position.

16. The cutting device according to claim 1, wherein the gripping device is arranged on a movement device which moves both vertically and horizontally relative to the blade table.

17. The cutting device according to claim 16, wherein the movement device is configured for the vertical and horizontal movement along respective linear axes and for the horizontal movement by way of a rotation about a vertical axis.

18. The cutting device according to claim 17, wherein two gripping devices which are arranged rotated by 180° and adjacently with respect to one another are provided, which gripping devices can be rotated in each case toward the cutting apparatus and away from the latter by way of a rotation on the part of the movement device.

19. The cutting device according to claim 16, wherein the movement device comprises a slide, via which it is arranged in a horizontally movable manner on a linear guide which is provided on the device frame.

20. The cutting device according to claim 19, wherein a holder is arranged on the slide such that it can be moved vertically, to which holder the gripping device is coupled or the two gripping devices are coupled.

21. The cutting device according to claim 20, wherein, for the vertical movement of the holder, a pivoting lever which is mounted pivotably on the slide and can be moved via an actuating element is provided, which pivoting lever is coupled to the holder.

22. The cutting device according to claim 16, wherein the movement device comprises a mounting plate, on which the one or the two gripping devices is/are arranged in each case in a linearly movable manner along a horizontal axis and/or along a vertical axis.

23. The cutting device according to claim 22, wherein the gripping device or in each case one gripping device is arranged on a vertical actuating device which is arranged on a horizontal linear guide on the mounting plate.

24. The cutting device according to claim 17, wherein a rotary drive is provided for rotational movement, which rotary drive is coupled to the gripping device or the two gripping devices.

25. The cutting device according to claim 24, wherein a holder is arranged on the slide such that it can be moved vertically, to which holder the gripping device is coupled or the two gripping devices are coupled, wherein the rotary drive is arranged on the holder.

26. The cutting device according to claim 25, wherein the movement device comprises a mounting plate, on which the one or the two gripping devices is/are arranged in each case in a linearly movable manner along a horizontal axis and/or along a vertical axis, wherein the rotary drive is connected to the mounting plate.

27. The cutting device according to claim 1, wherein a transport means, in particular a transport belt, is provided on the device frame for transporting the material web to the cutting apparatus.

28. The cutting device according to claim 27, wherein the gripping device is arranged on a movement device which moves both vertically and horizontally relative to the blade table, wherein the movement of the transport means and a horizontal movement of the movement device, during which the gripping device is seated on the material web and the magnetic element interacts with the magnetically couplable element, are synchronized for transporting the material web into the cutting position.

29. The cutting device according to claim 27, wherein, in order to move the transport means, a clamping means which acts on it releasably and can be moved in a linear manner is provided, or in that a transport roller, over which the transport means runs, and a drive motor which drives this transport roller are provided.

30. The cutting device according to claim 27, wherein one or more magnetic means which interact magnetically with the elements of the material web is/are provided below the upper run of the transport means.

31. The cutting device according to claim 27, wherein a transfer table which can be raised and lowered and guides the material web is provided between the end of the transport means and the blade table.

32. The cutting device according to claim 31, wherein the transfer table is mounted pivotably and can be raised and lowered with the end which is adjacent with respect to the blade table.

33. The cutting device according to claim 31, wherein the transfer table has a chamfer at the end which is adjacent with respect to the blade table, which chamfer is arranged adjacently with respect to a dimensionally compatible chamfer on the blade table in the lowered position.

34. The cutting device according to claim 1, wherein a recess for receiving a section of the gripping device, in particular a projection which is provided on its underside, is provided on the upper side of the blade table in the region of the end which faces away from the cutting apparatus.

35. The cutting device according to claim 1, wherein the blade table comprises a liner which is made, in particular, from plastic and forms its upper side which supports the web material.

36. An apparatus for producing and processing strips of a material web, of which strips each contains at least one magnetically couplable element, comprising a cutting device according to claim 1 and a receiving device which is connected downstream of this cutting device for receiving the separated strips on a carrier.

37. The apparatus according to claim 36, wherein the carrier which is occupied by strips is covered by way of a further carrier, with the result that the strips are arranged between the two carriers.

38. The apparatus according to claim 36, wherein the receiving device comprises a winding device, or a winding device is connected downstream of this receiving device, in which winding device the carrier or carriers occupied by the strips is/are wound to form a reel.
